(19) United States
(12) Patent Application Publication
(10) Pub. No.: US 2002/0025158 A1
(43) Pub. Date: Feb. 28, 2002

(54) Camera and reset device thereof

(76) Inventors: Tsutomu Wakabayashi, Yokohama-shi (JP); Sachio Mutou, Yokohama-shi (JP)

Correspondence Address: STAAS & HALSEY LLP, 700 11TH STREET, NW, SUITE 500, WASHINGTON, DC, 20001, US

(21) Appl. No.: 09/769,371

(22) Filed: Jan. 26, 2001

(30) Foreign Application Priority Data
Jan. 26, 2000 (JP) 2000-017397

(51) Int. Cl. G03B 17/18

(52) U.S. Cl. 396/266; 396/287; 396/299

(57) ABSTRACT

A camera and a camera reset device comprises a liquid crystal display unit that displays the camera setting and/or control state, a mode dial operated to select at least one mode setting position at which a function (P, CSM, ISO or the like) related to or not related to a photographing operation can be selected and set, a command dial operated to select and set the function, a reset operation unit that resets the function to a specific initial state (by depressing an exposure compensation button and a bracketing button at the same time) and an arithmetic operation circuit that indicates a reset by temporarily turning off the display at the liquid crystal display unit or the like when the reset operation unit has been operated.

### INCORPORATION BY REFERENCE

The disclosure of the following priority application is herein incorporated by reference: Japanese Patent Application No. 2000-017397 filed Jan. 26, 2000.

### BACKGROUND OF THE INVENTION

1. Field of the Invention

The present invention relates to a camera reset device capable of resetting a function related to a photographing operation after selecting and setting the function.

2. Related Art

Cameras capable of changing numerical values and settings by rotating a dial while depressing a button have been proposed in the prior art. While this type of camera enables to change a standard value or state, the original numerical value or the original state cannot be restored through a simple operation. As a solution, a camera having a set of operating members which are operated to reset the state to the original state has been proposed.

There is a problem with the camera in the prior art described above in that even when a reset operation is performed through the set of operating members by simultaneously depressing two buttons or the like, it is not easily ascertained whether or not a reset has been implemented through the operation.

In addition, there is a problem in that all the numerical values and settings that have been changed earlier are reset at the same time through the reset operation described above.

### SUMMARY OF THE INVENTION

An object of the present invention is to provide a camera in which it is easily ascertained whether or not a reset has been implemented and a reset device employed in the camera.

Another object of the present invention is to provide a camera in which a specific function can be reset independently and the function that has been reset can be ascertained easily and a reset device employed in the camera.

In order to achieve the objects described above, the camera according to the present invention comprises a display unit that displays a camera setting and/or a camera control state, a mode selection unit that selects at least one mode setting in which a function related to a photographing operation can be selected and set, a selection/setting operation unit that selects and sets the function, a reset operation unit that resets the function to a specific initial state and a reset control unit that implements reset display on the display unit when the reset operation unit has been operated.

A reset device that may be employed in this camera enables a release operation when the mode selection unit has selected, at least, one first mode setting in which a first function related to a photographing operation is selected and set and prohibits the release operation when the mode selection unit has selected at least one second mode setting in which a second function other than the first function is selected and set.

The reset control unit implements reset display by sustaining a no-display state over a predetermined short length of time. It may implement the reset display by momentarily turning off the display unit.

The reset operation unit may be provided with two operating members so that the reset control unit judges that the reset operation unit has been operated when the two operating members have been continuously operated together over a period equal to or greater than a predetermined length of time.

In order to achieve the objects described above, a reset device employed in the camera according to the present invention comprises a mode selection unit that selects, at least, one mode setting in which a function related to a photographing operation can be selected and set, a selection/setting operation unit that selects and sets the function, a reset operation unit that resets the function to a specific initial state and a reset control unit that allows only the function which can be selected and set in the mode setting selected by the mode selection unit to be reset.

This camera reset device enables a release operation when the mode selection unit has selected, at least, one first mode setting in which a first function related to a photographing operation is selected and set and prohibits the release operation when the mode selection unit has selected at least one second mode setting in which a second function other than the first function is selected and set.

The mode selection unit is capable of selecting, at least, one setting among a photographing condition setting, in which a photographing condition of a photographing operation started in response to a photographing start instruction issued in the camera can be set, a custom setting, in which value settings for a plurality of functions can be set individually and a film sensitivity setting in which the film sensitivity can be set. The details that can be reset by the reset control unit in response to an operation of the reset operation unit in a given specific setting selected by the mode setting unit only include the numerical value or the state that can be set in the corresponding setting.

### BRIEF DESCRIPTION OF THE DRAWINGS

FIG. 1 is a block diagram of a camera provided with the reset device in an embodiment of the present invention;

FIG. 2 illustrates the liquid crystal display unit of the camera in FIG. 1;

FIG. 3 is a top view of the camera in FIG. 1;

FIG. 4 is a flowchart of the main routine implemented in the camera reset device in the embodiment;

FIG. 5 is a flowchart of the main routine implemented in the camera reset device in the embodiment;

FIG. 6 is a flowchart of the setting/display operation subroutine implemented in the camera reset device in the embodiment;

FIG. 7 is a flowchart of the setting/display operation subroutine implemented in the camera reset device in the embodiment;

FIG. 8 is a flowchart of the setting/display operation subroutine implemented in the camera reset device in the embodiment;

FIG. 9 is a flowchart of the setting/display operation subroutine implemented in the camera reset device in the embodiment;

FIG. 10 is a flowchart of the setting/display operation subroutine implemented in the camera reset device in the embodiment;

FIG. 11 is a flowchart of the setting/display operation subroutine implemented in the camera reset device in the embodiment;

FIG. 12 is a flowchart of the setting/display operation subroutine implemented in the camera reset device in the embodiment;

FIG. 13 is a flowchart of the custom judging operation sub-routine implemented in the camera reset device in the embodiment;

FIG. 14 shows an example of a display brought up by the camera reset device in the embodiment;

FIG. 15 shows an example of a display brought up by the camera reset device in the embodiment;

FIG. 16 shows an example of a display brought up by the camera reset device in the embodiment;

FIG. 17 shows an example of a display brought up by the camera reset device in the embodiment;

FIG. 18 shows an example of a display brought up by the camera reset device in the embodiment;

FIG. 19 shows an example of a display brought up by the camera reset device in the embodiment;

FIG. 20 shows an example of a display brought up by the camera reset device in the embodiment;

FIG. 21 shows an example of a display brought up by the camera reset device in the embodiment;

FIG. 22 shows an example of a display brought up by the camera reset device in the embodiment;

FIG. 23 shows an example of a display brought up by the camera reset device in the embodiment;

FIG. 24 shows an example of a display brought up by the camera reset device in the embodiment;

FIG. 25 shows an example of a display brought up by the camera reset device in the embodiment;

FIG. 26 shows an example of a display brought up by the camera reset device in the embodiment;

FIG. 27 shows an example of a display brought up by the camera reset device in the embodiment; and

FIG. 28 shows an example of a display brought up by the camera reset device in the embodiment.

### DETAILED DESCRIPTION OF THE PREFERRED EMBODIMENT

The following is a detailed explanation of the camera reset device in an embodiment of the present invention, given in reference to the drawings.

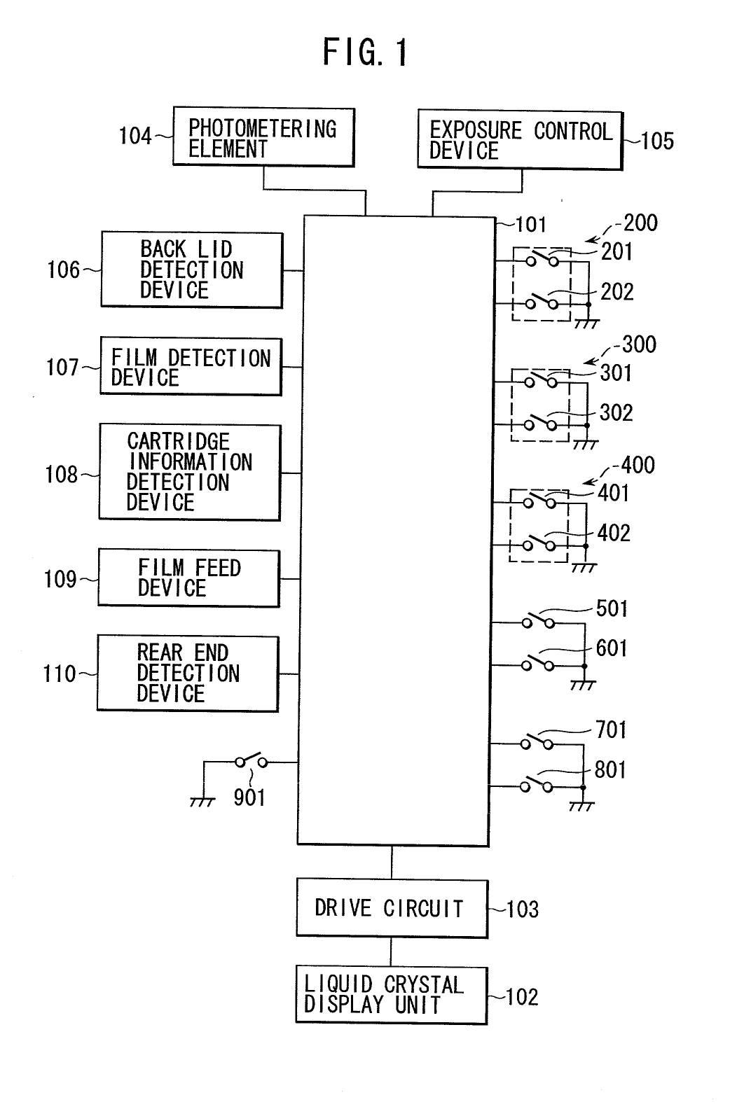

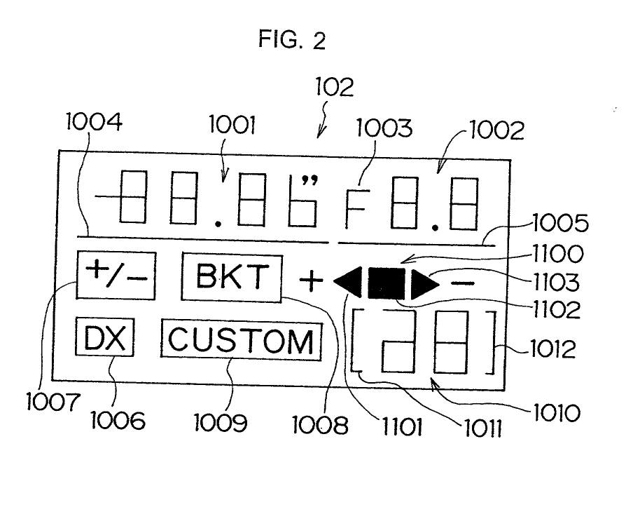

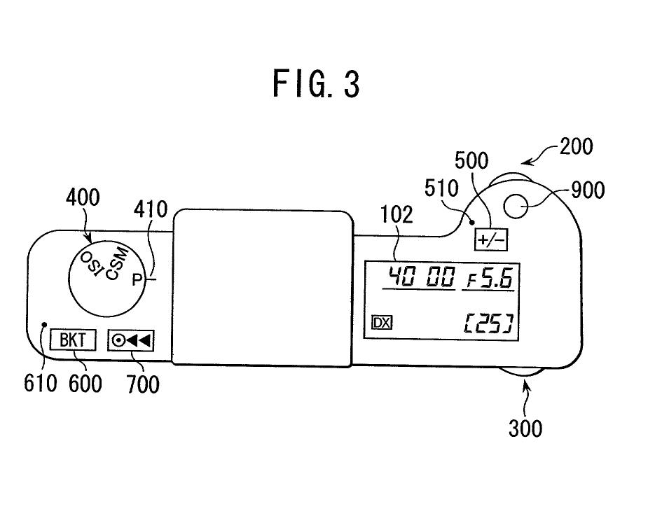

FIG. 1 is a block diagram of a camera provided with the reset device in the embodiment of the present invention, FIG. 2 illustrates the liquid crystal display unit of the camera in FIG. 1 and FIG. 3 is a top view of the camera.

An arithmetic operation circuit 101, which is constituted of a microcomputer and the like, receives outputs from various switches and devices to be detailed later, performs an arithmetic operation on the outputs thus received and controls various devices based upon the results of the arithmetic operation.

A liquid crystal display unit 102 is controlled based upon a signal output by a drive circuit 103 in correspondence to a signal output by the arithmetic operation circuit 101. It is to be noted that until the arithmetic operation circuit 101 outputs a subsequent signal after an initial signal output, the drive circuit 103 sustains output of a single signal and, as a result, the same display is sustained at the liquid crystal display unit 102.

At the liquid crystal display unit 102, various segments are arranged as shown in FIG. 2. At a shutter speed display segment 1001, the shutter speed, the film sensitivity, the exposure compensation value and a custom number are displayed. It is to be noted that a line segment 1004 becomes lit when displaying the shutter speed.

At an aperture value display segment 1002, the aperture value or the custom number setting (0: standard 1: setting change) is displayed. An F segment 1003 and a line segment 1005 are lit when displaying the aperture value. A DX mark 1006 becomes lit when the film sensitivity automatic setting is in effect. An exposure compensation mark 1007 becomes lit when exposure compensation setting is in effect or when an exposure compensation button (to be detailed later) is depressed. A bracketing mark 1008 becomes lit when bracketing setting is in effect. A custom mark 1009 is lit if any one of the custom numbers is set at a value other than the standard value.

A bracketing bar graph 1100 is lit when bracketing setting is in effect or when a bracketing button (to be detailed later) is depressed. Then, as the bracketing photographing operation progresses, the individual segments are turned off in sequence, in the order of the right side segment (the filled triangle pointing to the right) 1103 and the central segment (the filled rectangle) 1102 until all the segments 1101 (the filled triangle pointing to the left) through 1103 are turned off after photographing a third picture. At a counter display segment 1010, the value indicating the number of photographed pictures (counter value) is displayed. When the counter display is on, bracket marks ([)1011 and (]) 1012 on the two sides also become lit.

A photometering element 104 in FIG. 1 measures the brightness of the subject and outputs brightness information to the arithmetic operation circuit 101. An exposure control device 105 is constituted of a shutter, an aperture or an aperture control device and drive circuits which drive them. When a photographing instruction is issued by depressing a shutter release button which is to be described later, a photographing operation is performed by exposing the film while controlling the shutter speed and the aperture diameter at the values calculated by the arithmetic operation circuit.

A back lid detection device 106 detects the open/closed state of the back lid (not shown) and outputs a detection signal to the arithmetic operation circuit 101. A film detection device 107 detects the presence/absence of film and outputs a detection signal to the arithmetic operation circuit 101. A cartridge information detection device 108 detects a signal indicating the DX code related to the film sensitivity which is provided at the cartridge and outputs a detection signal to the arithmetic operation circuit 101.

A film feed device 109 performs an initial feed to set the first frame of the film in position or a frame feed to set subsequent photographic frames in position sequentially by winding up the film in response to an instruction issued by the arithmetic operation circuit 101 and also executes a rewind to wind the film into the cartridge. It is to be noted that the film feed device 109 achieves a rewind operation with less noise by implementing duty-drive on the motor constituting the motive power source for the film feed device 109 at approximately 75% if the silent rewind mode has been selected through custom setting. If, on the other hand, the fast rewind mode has been selected, the motor constituting the motive power source of the film feed device 109 is driven through full power supply to execute a fast rewind operation.

A rear end detection device 110, which is also connected to the film feed device 109, detects that the film has been wound up to the rear end and outputs a detection signal to the arithmetic operation circuit 101.

A sub-command dial 200 (see FIG. 3) is constituted of two switches 201 and 202 and through these switches, a decision can be made as to whether the sub-command dial 200 has been rotated to increase the setting value or to decrease the setting value. In addition, a main command dial 300 (see FIG. 3) is constituted of two switches 301 and 302 and through these switches, a decision can be made as to whether the main command dial 300 has been rotated to increase the setting value or to decrease the setting value.

A mode dial 400 is constituted of two switches 401 and 402, and as shown in FIG. 3, can assume one of three positions; a photographing position (P), a custom setting position (CSM) and a film sensitivity setting position (ISO). While a release operation is enabled when the mode dial 400 is set at the “P” position, a release operation is disabled when it is set at the “CSM” or the “ISO” position.

A switch 501 is interlocked with an exposure compensation button 500 (see FIG. 3) and is turned on with a depression of the exposure compensation button 500 and turned off with a release of the exposure compensation button. By rotating the main command dial 300 with the exposure compensation button 500 depressed and the mode dial 400 set at the photographing position, an exposure compensation value is displayed at the shutter speed display segment 1001 of the liquid crystal display unit 102 to enable exposure compensation value setting.

A switch 601 is interlocked with a bracketing button 600 (see FIG. 3) and is turned on with a depression of the bracketing button 600 and turned off with a release of the bracketing button 600. By rotating the main command dial 300 with the bracketing button 600 depressed and the mode dial 400 set at the photographing position, the bracketing mark 1008 and the bracketing bar graph 1100 become lit on the liquid crystal display unit 102 to enable bracketing setting.

A switch 701 is interlocked with a rewind button 700 (see FIG. 3) and is turned on with a depression of the rewind button 700 and turned off with a release of the rewind button 700. By holding down the rewind button 700 over a predetermined length of time when the mode dial 400 is set at the photographing position, a rewind operation is started.

A switch 901 is interlocked with a shutter release button 900 (see FIG. 3) and is turned on with a depression of the shutter release button 900 and turned off with a release of the shutter release button 900. By holding down the shutter release button 900 when the mode dial 400 is set at the photographing position, a photographing operation is started.

Next, a reset operation is explained.

If the exposure compensation button 500 with an indicator mark 510 and the bracketing button 600 with an indicator mark 610 are held down for 1 second or longer at the same time while the mode dial 400 is set at the photographing position, the exposure compensation value, the bracketing setting and the photographing condition are reset, as shown in FIG. 3.

If, on the other hand, the exposure compensation button 500 with the indicator mark 510 and the bracketing button 600 with the indicator mark 610 are held down together for 1 second or longer while the mode dial 400 is set at the custom setting position, all the contents of the custom settings become reset.

If the exposure compensation button 500 with the indicator mark 510 and the bracketing button 600 with the indicator mark 610 are held down together for 1 second or longer while the mode dial 400 is set at the film sensitivity setting position, the film sensitivity is reset to auto-setting.

As described above, the indicator marks 510 and 610 indicate that a reset is achievable by depressing the exposure compensation button 500 and the bracketing button 600 at the same time.

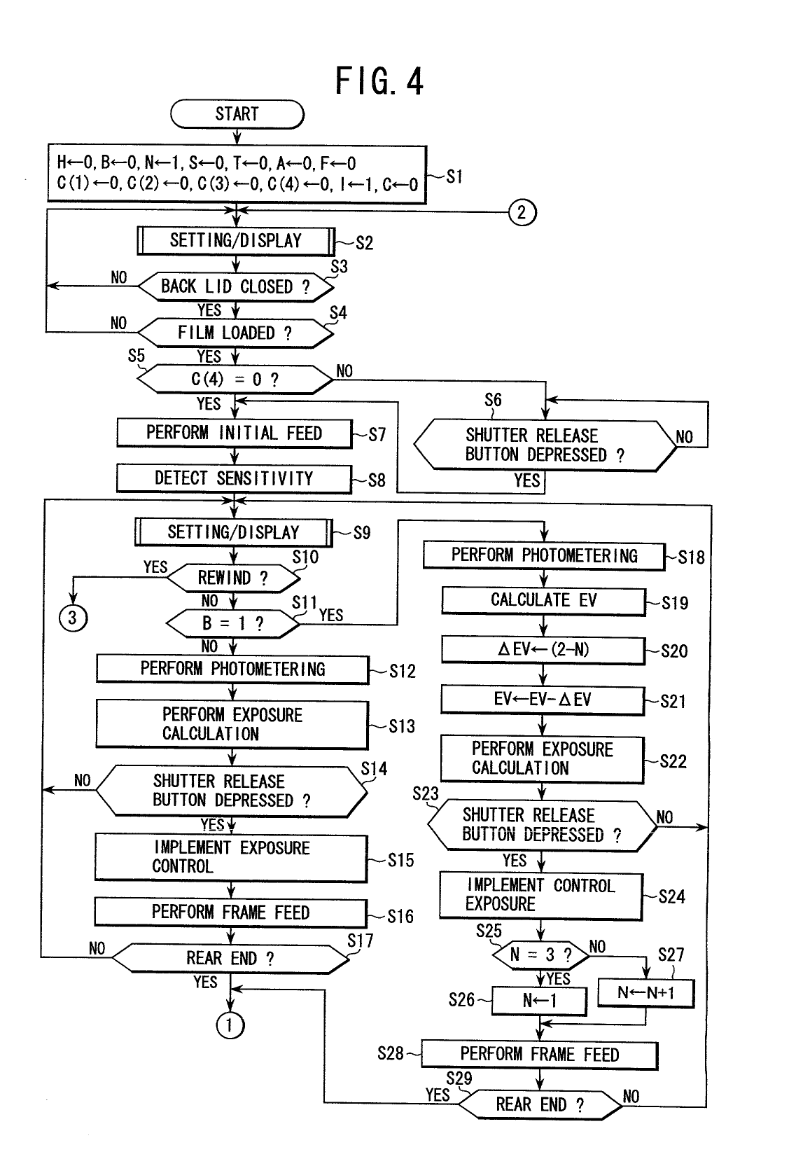

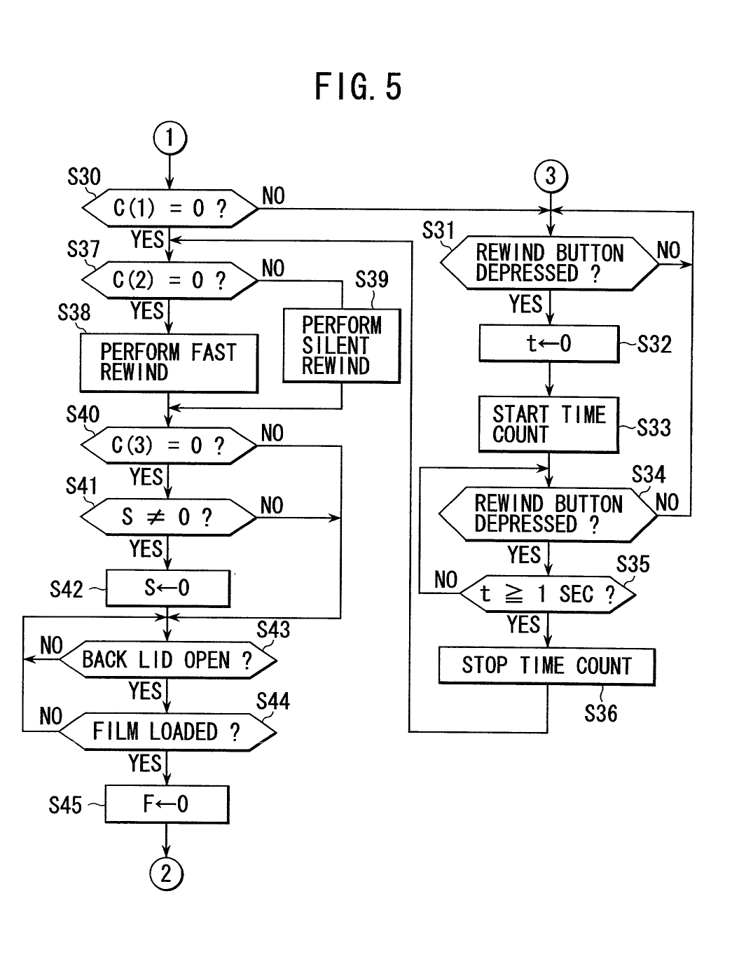

FIGS. 4 and 5 present a flowchart of the main routine of a program executed by the arithmetic operation circuit 101 of the camera reset device in the embodiment. When a battery (not shown) is loaded into the camera, the program starts to sequentially implement the processing that starts in step S1, as described below.

In step S1, flags and parameters used in operation control are set to initial values. Namely, flags B, C(1), C(2), C(3), C(4) and C are set to 0, parameters N and I are set to 1 and parameters H, S, T, A and F are set to 0. Details of the individual flags are explained below.

The flag B is a bracketing flag which is set to 1 when the bracketing setting is in effect and is set to 0 when the bracketing setting is cleared.

The flag C(1), which is a film rear end auto rewind flag, is set to 0 when the film rear end auto rewind setting is in effect. If a manual film rewind is set to start a rewind operation by holding down the rewind button 700 over a period equal to a predetermined length of time even when the film rear end has been detected, the flag C(1) is set to 1.

The flag C(2) is a silent rewind flag which is set to 1 when the silent rewind is selected and is set to 0 when the fast rewind is selected.

The flag C(3) is a film sensitivity automatic setting restore flag and is set to 0 when the film sensitivity automatic setting is to be restored after a film replacement. It is set to 1 if the setting to retain the current film sensitivity setting is in effect even when a film replacement has been detected.

The flag C(4) is an auto initial feed flag and is set to 0 when the setting to start a film initial feed operation in response to a closure of the back lid is in effect. The flag C(4) is set to 1 if the camera is set to start a film initial feed operation in response to a depression of the shutter release button after the back lid is closed.

The flag C is a custom setting flag which is set to 1 when 1 is set at one of the custom setting flags C(1), C(2), C(3) and C(4).

The parameter N indicates the frame number of the picture currently being photographed in a bracketing photographing operation. Since a single bracketing photographing operation is performed over three frames at a time in the embodiment, the value that may be taken for N is 1, 2 or 3. The relationship between the value of N and the display states of the bracketing bar graph segments 1101, 1102 and 1103 is shown below. In Table 1, when the camera is engaged in a photographing operation to take a picture in, for instance, the second frame, the value that may be assumed by N is 2, and two segments of the bracketing bar graph, i.e. 1101 and 1102, are lit.

TABLE 1

| N | BRACKETING BAR GRAPH |
|---|---|
| 1 | 1101, 1102, 1103 |
| 2 | 1101, 1102 |
| 3 | 1101 |

The parameter I indicates the custom item number. Since there are four custom items C(1), C(2), C(3) and C(4) in the embodiment, as described above, the value that may be taken by I is one among 1˜4. For instance, a value 2 assumed by the parameter I indicates the custom item number C(2)

The parameter H indicates the exposure compensation value. The parameter H and the exposure compensation value has the following relationship. It is assumed that exposure compensation is not selected if the parameter H is 0. ΔEV indicates the exposure compensation value when the apex operation display is on.

TABLE 2

| | EXPOSURE | |
|---|---|---|
| H | COMPENSATION VALUE | ΔEV |
| 0 | +0.0 | 0 |
| 1 | +0.5 | ½ |
| 2 | +1.0 | 1 |
| 3 | +1.5 | 1 ½ |
| 4 | +2.0 | 2 |
| 5 | +2.5 | 2 ½ |
| 6 | +3.0 | 3 |
| −1 | −0.5 | −½ |
| −2 | −1.0 | −1 |
| −3 | −1.5 | −1 ½ |
| −4 | −2.0 | −2 |
| −5 | −2.5 | −2 ½ |
| −6 | −3.0 | −3 |

The parameter S indicates the film sensitivity. It is to be noted that when the parameter S is 0, the film sensitivity automatic setting is in effect and the signal indicating the DX code related to the film sensitivity which is provided at the cartridge is detected by the cartridge information detection device 108 as explained earlier to be used in an arithmetic operation. The relationship among the parameter S, the film sensitivity and the film sensitivity SV set for an apex operation is presented below.

TABLE 3

| S | FILM SENSITIVITY | SV |
|---|---|---|
| 0 | DX(automatic setting) | — |
| 1 | 6 | 1 |
| 2 | 8 | 1 ⅓ |
| 3 | 10 | 1 ⅔ |
| 4 | 12 | 2 |
| 5 | 16 | 2 ⅓ |
| 6 | 20 | 2 ⅔ |
| 7 | 25 | 3 |
| 8 | 32 | 3 ⅓ |
| 9 | 40 | 3 ⅔ |
| 10 | 50 | 4 |
| 11 | 64 | 4 ⅓ |
| 12 | 80 | 4 ⅔ |
| 13 | 100 | 5 |
| 14 | 125 | 5 ⅓ |
| 15 | 160 | 5 ⅔ |
| 16 | 200 | 6 |
| 17 | 250 | 6 ⅓ |
| 18 | 320 | 6 ⅔ |
| 19 | 400 | 7 |
| 20 | 500 | 7 ⅓ |
| 21 | 640 | 7 ⅔ |
| 22 | 800 | 8 |
| 23 | 1000 | 8 ⅓ |
| 24 | 1250 | 8 ⅔ |
| 25 | 1600 | 9 |
| 26 | 2000 | 9 ⅓ |
| 27 | 2500 | 9 ⅔ |
| 28 | 3200 | 10 |
| 29 | 4000 | 10 ⅓ |
| 30 | 5000 | 10 ⅔ |
| 31 | 6400 | 11 |

The parameter T indicates the shutter speed. It is to be noted that the parameter T is set at the initial value 0 if a photometering operation has not been performed yet and the arithmetic operation circuit 101 cannot calculate a shutter speed. The relationship among the parameter T, the shutter speed and the shutter speed TV used in an apex operation is presented below.

TABLE 4

| T | SHUTTER SPEED | TV |
|---|---|---|
| 0 | BLANK | — |
| 1 | 1 | 0 |
| 2 | 2 | 1 |
| 3 | 4 | 2 |
| 4 | 8 | 3 |
| 5 | 15 | 4 |
| 6 | 30 | 5 |
| 7 | 60 | 6 |
| 8 | 125 | 7 |
| 9 | 250 | 8 |
| 10 | 500 | 9 |
| 11 | 1000 | 10 |
| 12 | 2000 | 11 |
| 13 | 4000 | 12 |

The parameter A indicates the aperture value. It is to be noted that the parameter A is set at the initial value 0 if a photometering operation has not been performed yet and the arithmetic operation circuit 101 cannot calculate an aperture value. The relationship among the parameter A, the aperture value and the aperture value AV used in an apex operation is presented below.

TABLE 5

| A | APERTURE VALUE | AV |
|---|---|---|
| 0 | BLANK | — |
| 1 | F1 | 0 |
| 2 | F1.4 | 1 |
| 3 | F2 | 2 |
| 4 | F2.8 | 3 |
| 5 | F4 | 4 |
| 6 | F5.6 | 5 |
| 7 | F8 | 6 |
| 8 | F11 | 7 |
| 9 | F16 | 8 |
| 10 | F22 | 9 |
| 11 | F32 | 10 |

The parameter F indicates the number of frames (at the film counter) of pictures that have been taken it is to be noted that the film counter indicates E when the parameter F is 0. The relationship between the parameter F and the film counter indication is presented below.

TABLE 6

| F | FILM COUNTER INDICATION |
|---|---|
| 0 | E |
| 1 | 1 |
| 2 | 2 |
| 3 | 3 |
| 4 | 4 |
| 5 | 5 |
| 6 | 6 |
| 7 | 7 |
| 8 | 8 |
| 9 | 9 |
| 10 | 10 |
| 11 | 11 |
| 12 | 12 |
| 13 | 13 |
| 14 | 14 |
| 15 | 15 |
| 16 | 16 |
| 17 | 17 |
| 18 | 18 |
| 19 | 19 |
| 20 | 20 |
| 21 | 21 |
| 22 | 22 |
| 23 | 23 |
| 24 | 24 |
| 25 | 25 |
| 26 | 26 |
| 27 | 27 |
| 28 | 28 |
| 29 | 29 |
| 30 | 30 |
| 31 | 31 |
| 32 | 32 |
| 33 | 33 |
| 34 | 34 |
| 35 | 35 |
| 36 | 36 |

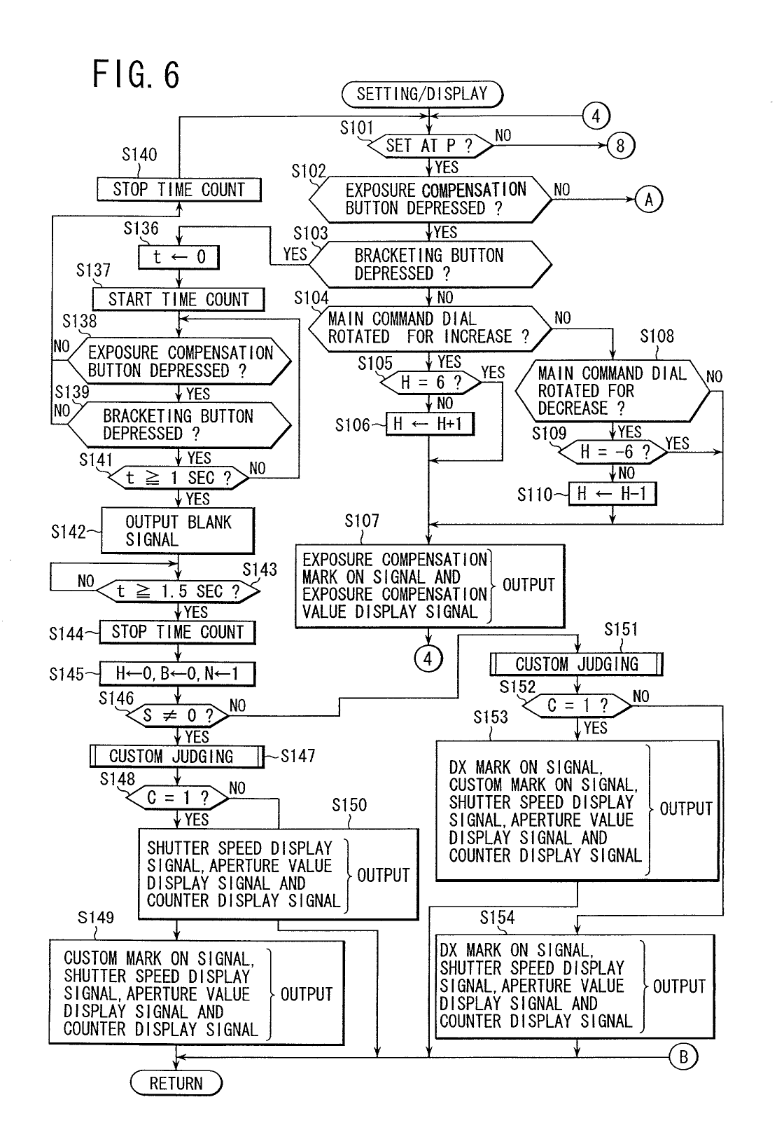

The operation proceeds to step S2 once the initial settings for the various flags and parameters are completed. In step S2, display of information related to the photographing operation and display effected by operating various operating members are implemented. FIGS. 6˜12 present a flowchart of the setting/display operation subroutine implemented by the arithmetic operation circuit 101 of the camera reset device in the embodiment. The setting/display operation starts in step S101 in FIG. 6.

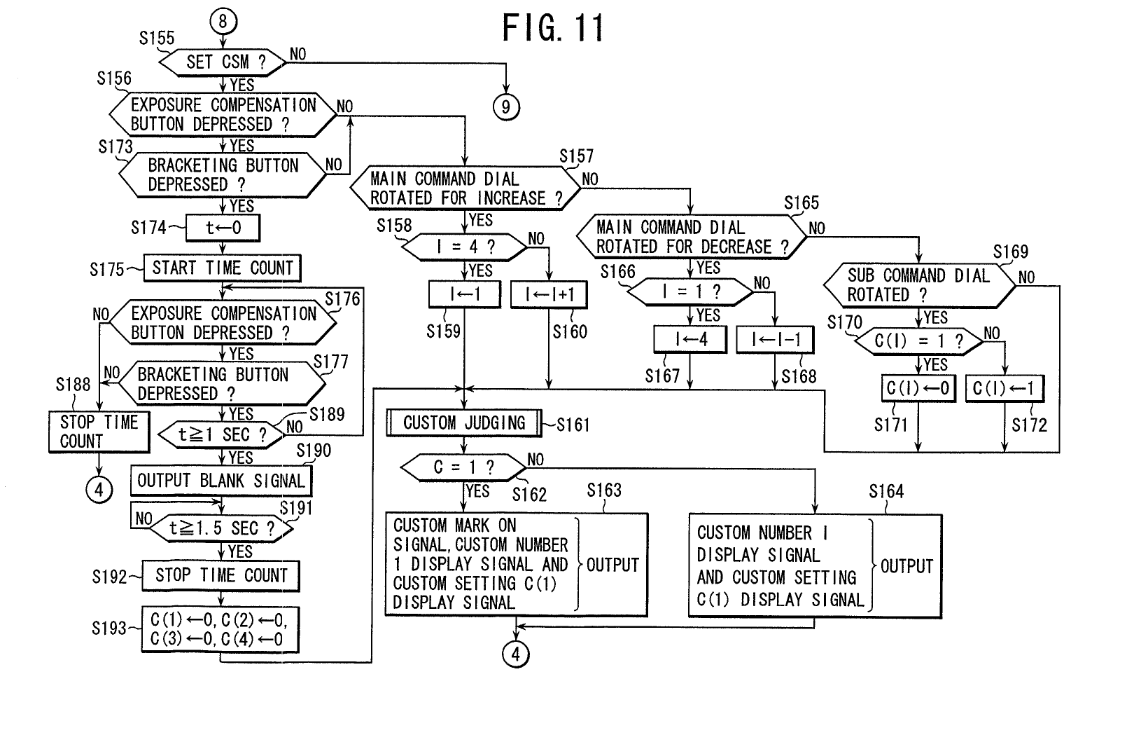

In step S101, a decision is made as to whether or not the character “P” at the exposure mode dial 400 in FIG. 3 is set facing opposite an indicator mark 410 based upon the states of the switches 401 and 402. If it is decided that the character “P” is facing opposite the indicator mark 410, the operation proceeds to step S102, whereas if it is decided that the character “P” is not facing opposite the indicator mark 410, the operation proceeds to step S155 in FIG. 11.

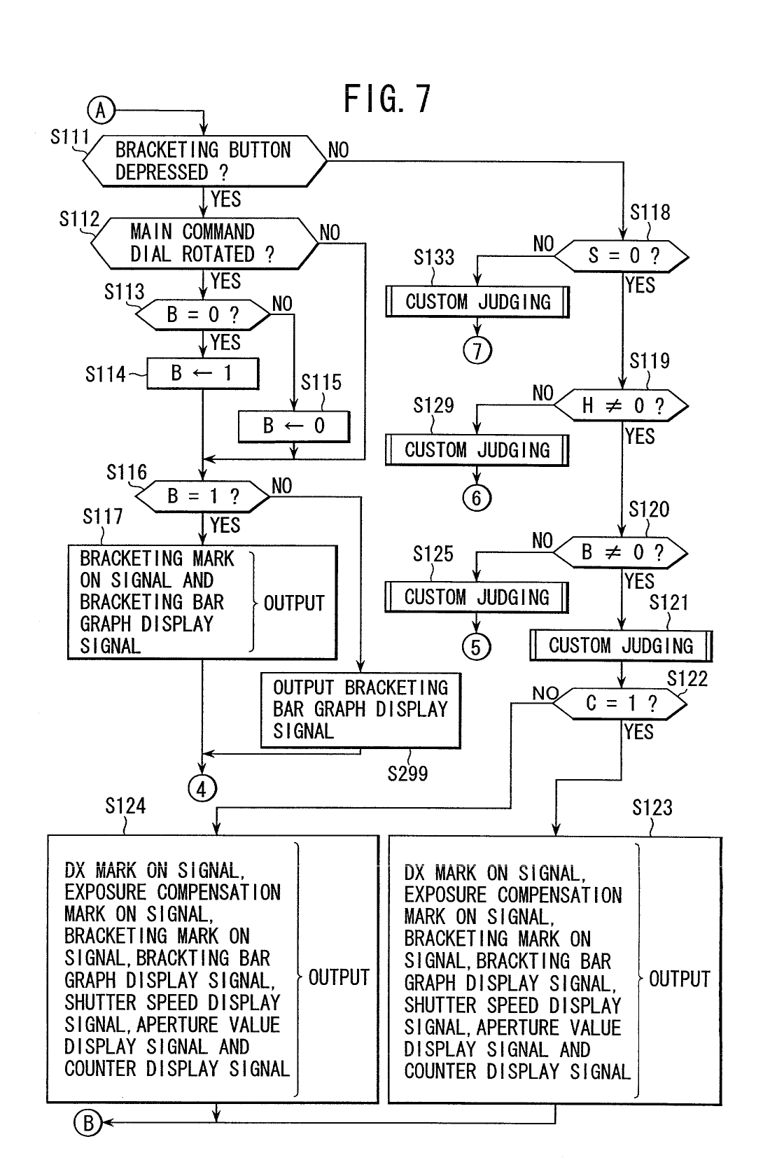

In step S102, a decision is made through the status of the switch 501 as to whether or not the exposure compensation button 500 in FIG. 3 is depressed. If it is decided that the exposure compensation button 500 is depressed, the operation proceeds to step S103, whereas if it is decided that it is not depressed, the operation proceeds to step S111 in FIG. 7.

In step S103, a decision is made through the status of the switch 601 as to whether or not the bracketing button 600 in FIG. 3 is depressed. If it is decided that the bracketing button 600 is depressed, it is judged that a reset operation is in progress and the operation proceeds to step S136 to implement reset processing in a subsequent procedure. If, on the other hand, the bracketing button 600 is determined not to be depressed, it is judged that an operation for exposure compensation instead of a reset operation is in progress and the operation proceeds to step S104 to implement exposure compensation processing.

In step S104, a decision is made based upon signals provided from the switch 301 and the switch 302 as to whether or not the main command dial 300 in FIG. 3 has been rotated to increase the setting value (rotated in the counter-clockwise direction in the embodiment). If the main command dial 300 has been rotated along the counter-clockwise direction, the operation proceeds to step S105, but the operation proceeds to step S108 otherwise.

In step S105, a decision is made as to whether or not the value of the parameter H is 6. If the parameter H is not 6, the operation proceeds to step S106, whereas the operation skips step S106 and proceeds to step S107 if the value of the parameter H is 6.

In step S106, the value of the parameter H is incremented by 1. Since the value that may be assumed for the parameter H is an integer within the range of −6˜+6 in the embodiment as explained earlier, a decision is made as to whether or not the parameter H indicates the maximum value when the operation to increase the setting value has been performed. If the value of the parameter H is the maximum value 6, the operation skips step S106 to invalidate the rotation of the main command dial 300 for increasing the setting value.

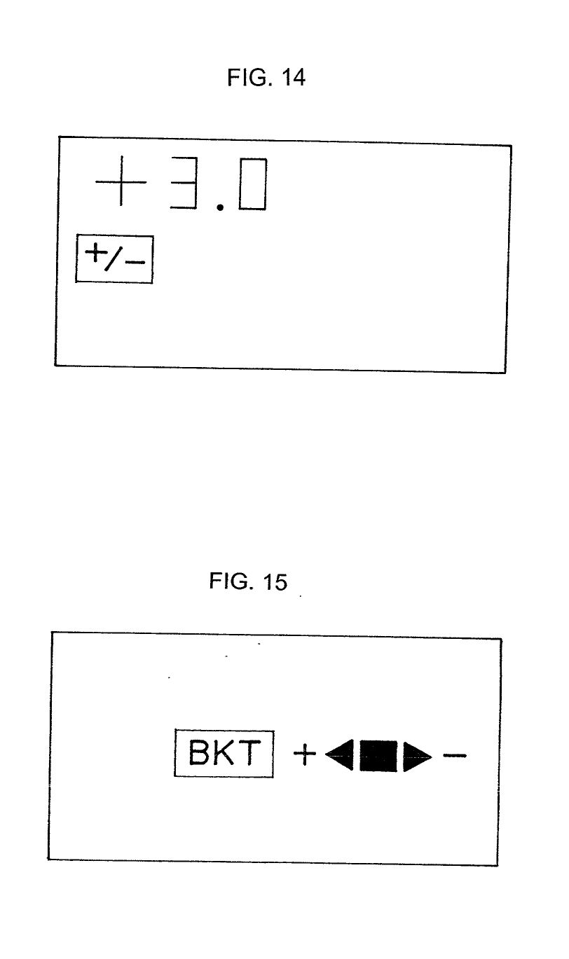

In step S107, a display signal for turning on the exposure compensation mark 1007 in FIG. 2 and a signal for displaying the exposure compensation value based upon the parameter H are output to the drive circuit 103 before the operation returns to step S101. At this time, based upon the display signals thus output, the drive circuit 103 drives the liquid crystal display units 102 to bring up the display. FIG. 14 presents an example of a display brought up by depressing the exposure compensation button 500 when H=6, i.e., when the exposure compensation value is +3.0.

If, on the other hand, it is decided in step S104 that the main command dial 300 has not been rotated in the counter-clockwise direction, the processing in step S108 and subsequent steps is implemented.

In step S108, a decision is made based upon signals provided from the switches 301 and 302 as to whether or not the main command dial 300 in FIG. 3 has been rotated to decrease the setting value (rotated in the clockwise direction in the embodiment). If the main command dial 300 has been rotated in the clockwise direction, the operation proceeds to step S109, but it is judged that the main command dial 300 has not been rotated otherwise and the operation proceeds to step S107 explained earlier.

In step S109, a decision is made as to whether or not the value of the parameter H is −6. If the value is not −6, the operation proceeds to step S110, whereas the operation skips step S110 and proceeds to step S107 if the value is −6.

In step S110, the value of the parameter H is decremented by one. Since the value of the parameter H is an integer within the range of −6˜+6 in the embodiment as explained earlier, a decision is made as to whether or not the value of the parameter H is the minimum value if an operation to decrease the setting value has been performed. If the parameter H is the minimum value −6, the operation skips the step S110 to invalidate the rotation of the main command dial 300 for decreasing the setting value.

If it is decided in step S102 that the exposure compensation button 500 is not depressed, the processing in step S111 and subsequent steps in FIG. 7 is implemented.

In step S111, a decision is made based upon a signal provided from the switch 601 as to whether or not the bracketing button 600 in FIG. 3 is depressed. If the bracketing button 600 is depressed, it is judged that an operation to select the bracketing setting has been performed and the operation proceeds to step S112, whereas it is judged that no operation to select the bracketing setting has been performed if the bracketing button 600 is not depressed and the operation proceeds to step S118.

In step S112, a decision is made based upon signals provided from the switches 301 and 302 as to whether or not the main command dial 300 in FIG. 3 has been rotated. The operation proceeds to step S113 if the main command dial 300 has been rotated, but the operation proceeds to step S116 otherwise.

In step S113, a decision is made as to whether or not the value at the flag B is 0. If it is determined that the flag B is 0, the operation proceeds to step S114, but the operation proceeds to step S115 otherwise. Namely, the operation proceeds to step S114 to clear the flag B if a bracketing photographing operation has been selected (B=1) and the operation proceeds to step S115 to set the flag B if a bracketing photographing operation has been cleared (B=0). In step S114, 1 is set for the flag B and the operation proceeds to step S116. In step S115, the flag B is set at 0 before the operation proceeds to step S116.

In step S116, in order to bring up a display, a decision is made as to whether or not the value of the flag B is 1. If the value of the flag B is 1, the operation proceeds to step S117, but the operation proceeds to step S299 otherwise.

In step S117, a display signal for turning on the bracketing mark 1008 in FIG. 2 and a signal for displaying the bracketing bar graph 1100 based upon the value of the parameter N are output to the drive circuit 103, before the operation returns to step S101. At this time, the drive circuit 103 drives the liquid crystal display unit 102 to bring up the display based upon the display signals thus output. FIG. 15 shows an example of a display brought up by depressing the bracketing button 600 when B=1 and N=3.

In step S299, a signal for displaying the bracketing bar graph 1100 based upon the value of the parameter N is output to the drive circuit 103, before the operation returns to step S101. The drive circuit 103 drives the liquid crystal display unit 102 to bring up the display based upon the display signal thus output.

If it is decided in step S111 that the bracketing button 600 is not depressed, the processing in step 118 and subsequent steps is implemented. This processing constitutes display processing implemented in preparation for a normal photographing operation.

In step S118, a decision is made as to whether or not the value of the parameter S is 0. If the value is 0, i.e., if the film sensitivity automatic setting (DX) is in effect, the operation proceeds to step S119, whereas the operation proceeds to step S133 if the value of the parameter S is 1.

In step S119, a decision is made as to whether the value of the parameter H is a value other than 0 or 0. If it is decided that the value is other than 0, i.e., if the exposure compensation setting is in effect, the operation proceeds to step S120, whereas if the value is 0, i.e., if the exposure compensation is not selected, the operation proceeds to step S129.

In step S120, a decision is made as to whether the value of the flag B is 0 or a value other than 0. If the value is other than 0 (1), i.e., if bracketing photographing is selected, the operation proceeds to step S121, whereas if the value is 0, i.e., if bracketing photographing is not selected, the operation proceeds to step S125.

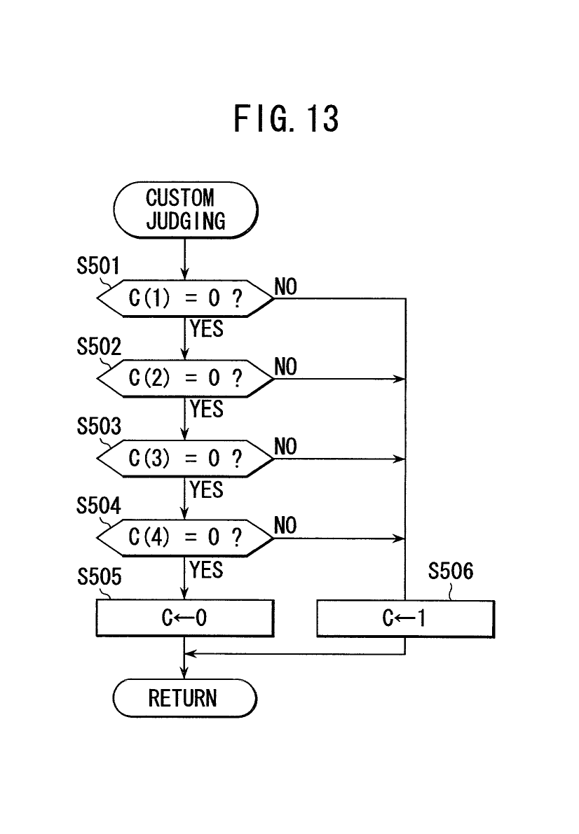

In step S121, a decision is made as to whether or not at least one custom setting item is set. Details of the method adopted to make this decision is now explained in reference to FIG. 13. FIG. 13 is a flowchart of the custom setting judging operation subroutine performed by the arithmetic calculation circuit 101 of the camera reset device in the embodiment.

In step S501, a decision is made as to whether or not the value of the flag C(1) is set to 0. If the value of the flag C(1) is 0, it is judged that the custom setting item 1 is not set and the operation proceeds to step S502, whereas if 1 is set for the flag C(1), it is judged that the custom setting item 1 is set and the operation proceeds to step S506.

In step S502, a decision is made as to whether not the value of the flag C(2) is set to 0. If the value of the flag C(2) is 0, it is judged that the custom setting item 2 is not set and the operation proceeds to step S503, whereas if 1 is set for the flag C(2), it is judged that the custom setting item 2 is set and the operation proceeds to step S506.

In step S503, a decision is made as to whether not the value of the flag C(3) is set to 0. If the value of the flag C(3) is 0, it is judged that the custom setting item 3 is not set and the operation proceeds to step S504, whereas if 1 is set for the flag C(3), it is judged that the custom setting item 3 is set and the operation proceeds to step S506.

In step S504, a decision is made as to whether not the value of the flag C(4) is set to 0. If the value of the flag C(4) is 0, it is judged that the custom setting item 4 is not set and the operation proceeds to step S505, whereas if 1 is set for the flag C(4), it is judged that the custom setting item 4 is set and the operation proceeds to step S506.

If the operation reaches step S505 through the flow in which the processing is performed in the order of step S501 step S502 step S503 step S504 step S505, the flags C(1), C(2), C(3) and C(4) are all set at 0. Accordingly, 0 is set at the custom setting flag C in step S505 before the operation returns to the next step in the custom judging operation.

If the operation is performed through the flow leading to step S506, at least one of the flags C(1), C(2), C(3) and C(4) is set at 1. Accordingly, it is judged in step S506 that at least one of the custom setting items is set and the custom setting flag C is set at 1 before the operation returns to the next step in the custom judging operation.

The custom setting judging operation in FIG. 13 is thus completed and the operation returns to step S122 in FIG. 7. In step S122 in FIG. 7, a decision is made as to whether or not 1 is set at the custom setting flag C. If 1 is set at the custom setting flag C, it is judged that custom setting is in effect and the operation proceeds to step S123, whereas it is judged that custom setting is not in effect if 0 is set at the custom setting flag C and the operation proceeds to step S124.

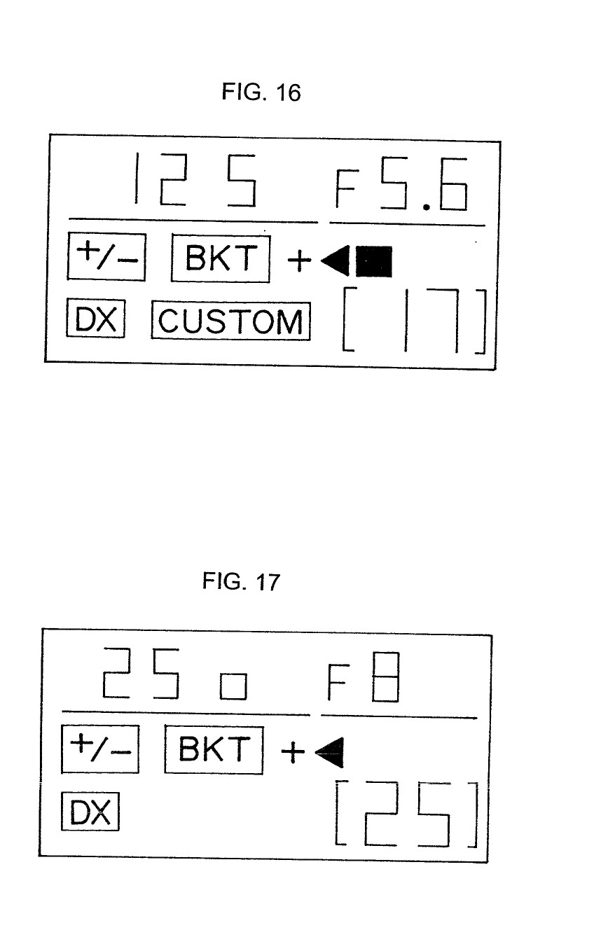

In step S123, a signal for turning on the DX mark 1006, a signal for turning on the exposure compensation mark 1007, a signal for turning on the bracketing mark 1008, a signal for turning on the custom mark 1009, a signal for displaying the bracketing bar graph 1100 based upon the value of the parameter N, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the displays signal thus output. FIG. 16 presents an example of a display brought up at this point.

It is to be noted that if an exposure calculation in step S13 or step S22 to be detailed later has not been performed, the shutter speed and the aperture value cannot be calculated, and accordingly, 0 is set for the parameters T and A in step S1, to leave the display of the shutter speed and the aperture value blank (to turn off the shutter speed display segment 1001 and the aperture value display segment 1002).

In addition, if no film has been loaded in the camera, the parameter F is 0 and “E” is brought up on the counter to clearly indicate that the camera is not loaded with film. When displaying the shutter speed, the line segment 1004 is also lit, when displaying the aperture value, the line segment 1005 is also lit and when displaying the counter value, the brackets 1011 and 1012 are also lit.

In step S124, a signal for turning on the DX mark 1006, a signal for turning on the exposure compensation mark 1007, a signal for turning on the bracketing mark 1008, a signal for displaying the bracketing bar graph 1100 based upon the value of the parameter N, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 17 presents an example of a display brought up at this point.

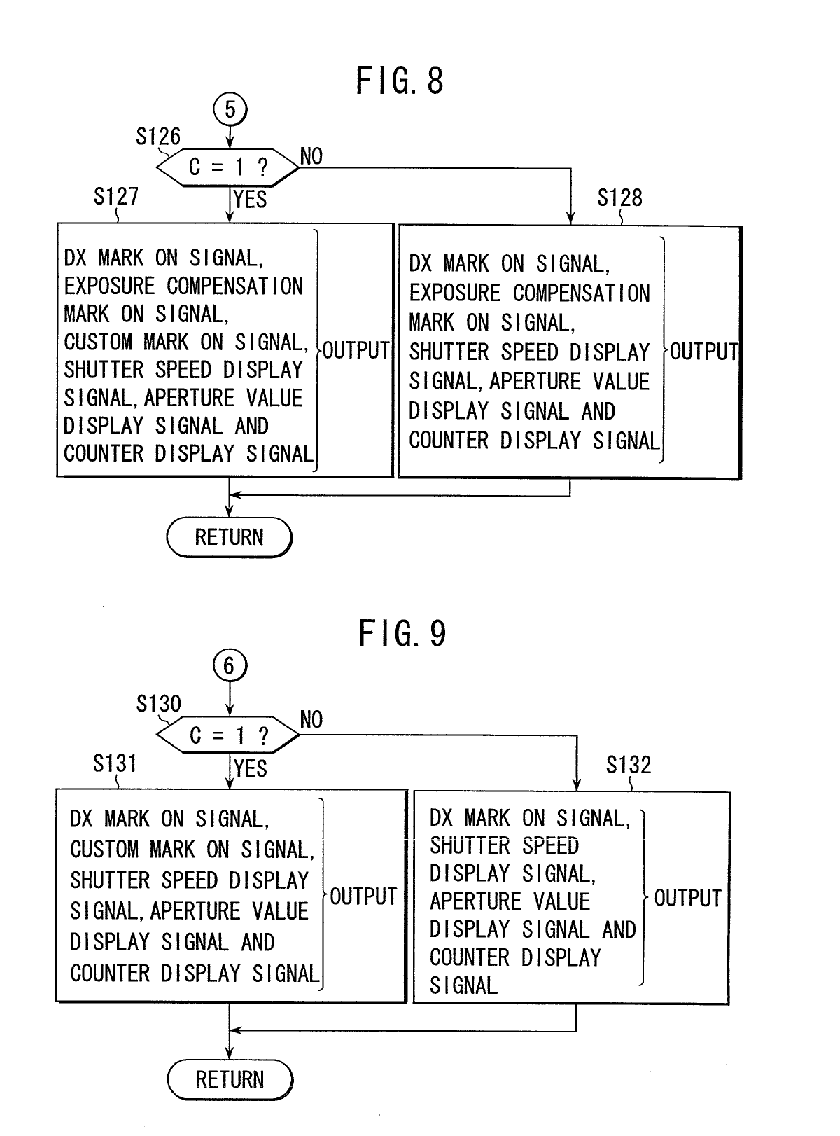

If it is decided that B=0 in step S120 explained earlier in reference to FIG. 7, the operation proceeds to step S125. In step S125, a custom judging operation identical to the custom judging operation explained earlier is performed before the operation proceeds to step S126 in FIG. 8. In step S126, a decision is made as to whether or not 1 is set at the custom setting flag C. If 1 is set at the custom setting flag C, it is judged that custom setting is in effect and the operation proceeds to step S127, whereas if 0 is set at the custom setting flag C, it is judged that the custom setting is not in effect and the operation proceeds to step S128.

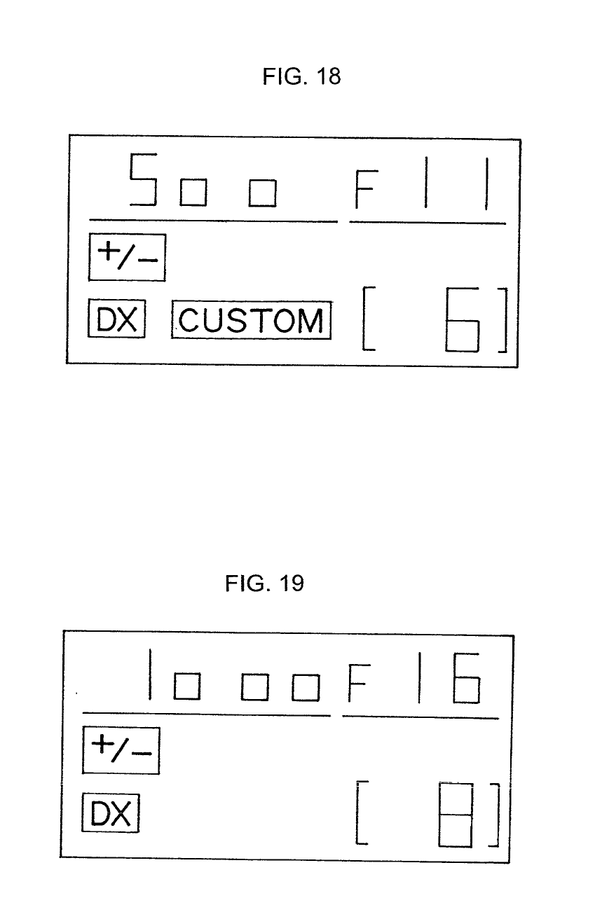

In step S127, a signal for turning on the DX mark 1006, a signal for turning on the exposure compensation mark 1007, a signal for turning on the custom mark 1009, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 18 presents an example of a display brought up at this point.

In step S128, a signal for turning on the DX mark 1006, a signal for turning on the exposure compensation mark 1007, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 19 presents an example of a display brought up at this point.

If it is decided that H=0 in step S119 explained earlier in reference to FIG. 7, the operation proceeds to step S129. In step S129, a custom judging operation identical to the custom judging operation explained earlier is performed before the operation proceeds to step S130 in FIG. 9. In step S130, a decision is made as to whether or not 1 is set at the custom setting flag C. If 1 is set at the custom setting flag C, it is judged that custom setting is in effect and the operation proceeds to step S131, whereas if 0 is set at the custom setting flag C, it is judged that the custom setting is not in effect and the operation proceeds to step S132.

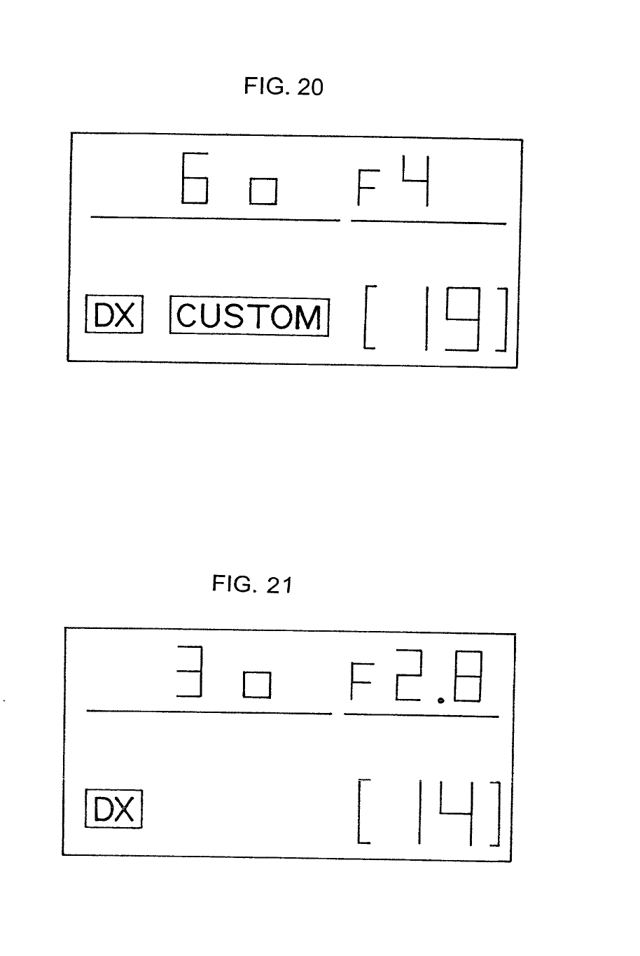

In step S131, a signal for turning on the DX mark 1006, a signal for turning on the custom mark 1009, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 20 presents an example of a display brought up at this point.

In step S132, a signal for turning on the DX mark 1006, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 21 presents an example of a display brought up at this point.

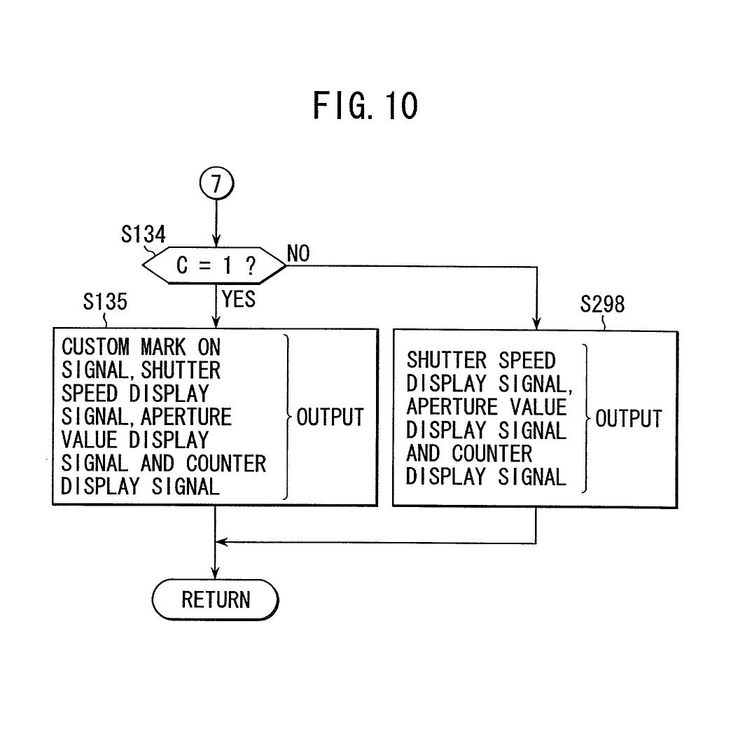

If it is decided that S≠0 in step S118 explained earlier in reference to FIG. 7, the operation proceeds to step S133. In step S133, a custom judging operation identical to the custom judging operation explained earlier is performed before the operation proceeds to step S134 in FIG. 10. In step S134, a decision is made as to whether or not 1 is set at the custom setting flag C. If 1 is set at the custom setting flag C, it is judged that custom setting is in effect and the operation proceeds to step S135, whereas if 0 is set at the custom setting flag C, it is judged that the custom setting is not in effect and the operation proceeds to step S298.

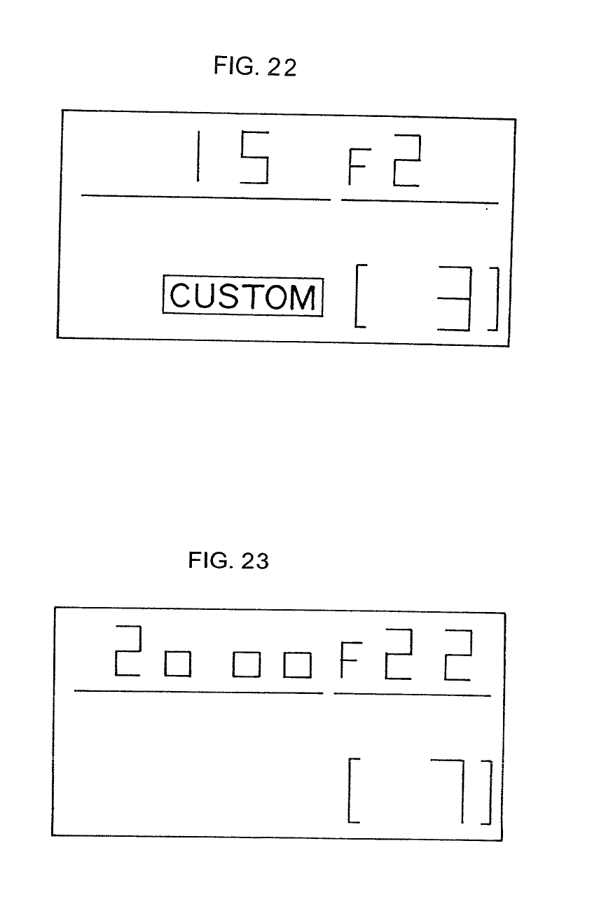

In step S135, a signal for turning on the custom mark 1009, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 22 presents an example of a display brought up at this point.

In step S298, a signal for displaying the shutter speed based upon the value of the parameter T, a signal for displaying the aperture value based upon the value of the parameter A and a signal for displaying the counter value based upon the value of the parameter F are output to the drive circuit 103 and the operation returns to the next step in the “setting/display” operation in FIG. 4. At this time, the drive circuit 103 brings up the display by driving the liquid crystal display unit 102 based upon the display signal thus output. FIG. 23 presents an example of a display brought up at this point.

If it is decided in step S103 in FIG. 6 based upon the signal provided from the switch 601 that the bracketing button 600 shown in FIG. 3 is depressed, it is judged that a reset operation is in progress and the operation proceeds to step S136 to engage in reset processing.

In step S136 in FIG. 6, the length of time t that has been counted is set to 0. In step S137, a time count starts.

In step S138, a decision is made based upon the signal provided from the switch 501 as to whether or not the exposure compensation button 500 in FIG. 3 is depressed. If the exposure compensation button 500 is determined to be depressed, it is judged that the reset operation is in progress and the operation proceeds to step S139, whereas if the exposure compensation button 500 is determined not to be depressed, it is judged that the reset operation has been interrupted and the operation proceeds to step S140.

In step S139, a decision is made based upon the signal provided from the switch 601 as to whether or not the bracketing button 600 in FIG. 3 is depressed. If the bracketing button 600 is determined to be depressed, it is judged that the reset operation is in progress and the operation proceeds to step S141, whereas if the bracketing button 600 is determined not to be depressed, it is judged that the reset operation has been interrupted and the operation proceeds to step S140.

In step S140, the time count is stopped and the operation returns to step S101 explained earlier. In step S141, a decision is made as to whether or not the length of time t that has been counted is equal to or greater than 1 second. If the time count is 1 second or longer, it is judged that the reset operation has been completed (the exposure compensation button 500 and the bracketing button 600 have been held down at the same time for 1 second or longer) and the operation proceeds to step S142, whereas if the time count is less than 1 second, it is judged that the reset operation has not yet been completed and the operation returns to step S138.

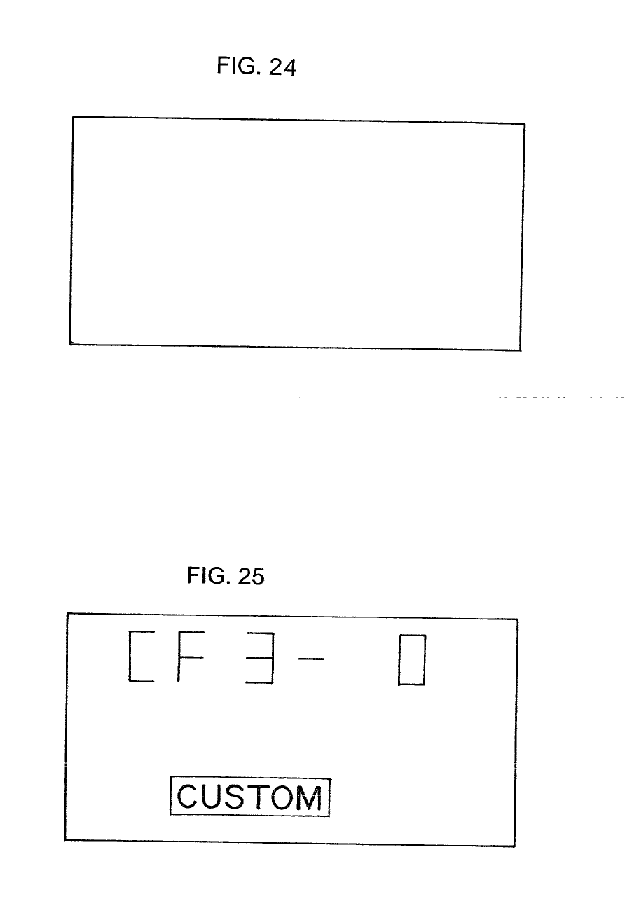

In step S142, a blank signal (a signal for turning off all segments at the liquid crystal display unit 102) is output to the drive circuit 103. In response to this signal, the liquid crystal display unit 102 becomes completely turned off. FIG. 24 shows the display state at the liquid crystal display unit 102 at this point.

In step S143, a decision is made as to whether or not the length of time t that has been counted is equal to or greater than 1.5 seconds. If the time count is 1.5 seconds or longer, the operation proceeds to step S144, whereas if the time count is less than 1.5 seconds, the operation awaits a time count of 1.5 seconds or longer in step S143. Thus, the liquid crystal display unit 102 sustains the display state shown in FIG. 24 over, at least, 0.5 seconds (500 msec). In step S144, the time count is stopped.

In step S145, 0 is set for the parameters H and B and 1 is set for the parameter N. As a result, only the function that can be set while the mode dial 400 is set to “P” is cleared. Namely, only the function that can be set if the mode dial 400 is set to the “P” position is reset. That a reset has been effected can be easily ascertained since the display at the liquid crystal display unit 102 is turned off (blank display) over, at least, 0.5 seconds (turned off momentarily) in step S143.

In step S146, a decision is made as to whether or not the value of the parameter S is 0. If the value is not 0, i.e., if the film sensitivity automatic setting (DX) is in effect, the operation proceeds to step S147, whereas if the value is 1, the operation proceeds to step S151.

In step S147, a custom judging operation identical to the custom judging operation explained earlier is performed. In step S148, a decision is made as to whether or not 1 is set at the custom setting flag C. If the custom setting flag C is determined to be set at 1, it is judged that custom setting is in effect and the operation proceeds to step S149, whereas if 0 is set at the custom setting flag C, it is judged that custom setting is not in effect and the operation proceeds to step S150.

In step S149, display processing identical to that in step S135 explained in reference to FIG. 10 is implemented and then, the operation returns to the next step in the “setting/display” processing in FIG. 4. In step S150, display processing identical to that in step S298 explained earlier in reference to FIG. 10 is implemented and then the operation returns to the next step in the “setting/display” processing in FIG. 4.

In step S151 in FIG. 6, a custom judging operation identical to the custom judging operation explained earlier is performed. In step S152, a decision is made as to whether or not 1 is set at the custom setting flag C. If the custom setting flag C is determined to be set at 1, it is judged that custom setting is in effect and the operation proceeds to step S153, whereas if 0 is set at the custom setting flag C, it is judged that custom setting is not in effect and the operation proceeds to step S154.

In step S153, display processing identical to that in step S131 explained in reference to FIG. 9 is implemented and then the operation returns to the next step in the “setting/display” processing in FIG. 4. In step S154, display processing identical to that in step S132 explained earlier in reference to FIG. 9 is implemented and then the operation returns to the next step in the “setting/display” processing in FIG. 4.

As explained above, the operation can exit the “setting/display” processing (step S2 or step S9) in FIG. 4 unless the character “P” at the exposure mode dial 400 is facing opposite the indicator mark 410 and either the exposure compensation button 500 or the bracketing button 600 is depressed. In other words, a release operation is enabled when the exposure mode dial 400 is set at the “P” position.

If it is decided based upon the states of the switches 401 and 402 in step S101 in FIG. 6 that the character “P” at the exposure mode dial 400 in FIG. 3 is not facing opposite the indicator mark 410, the operation proceeds to step S155 in FIG. 11.

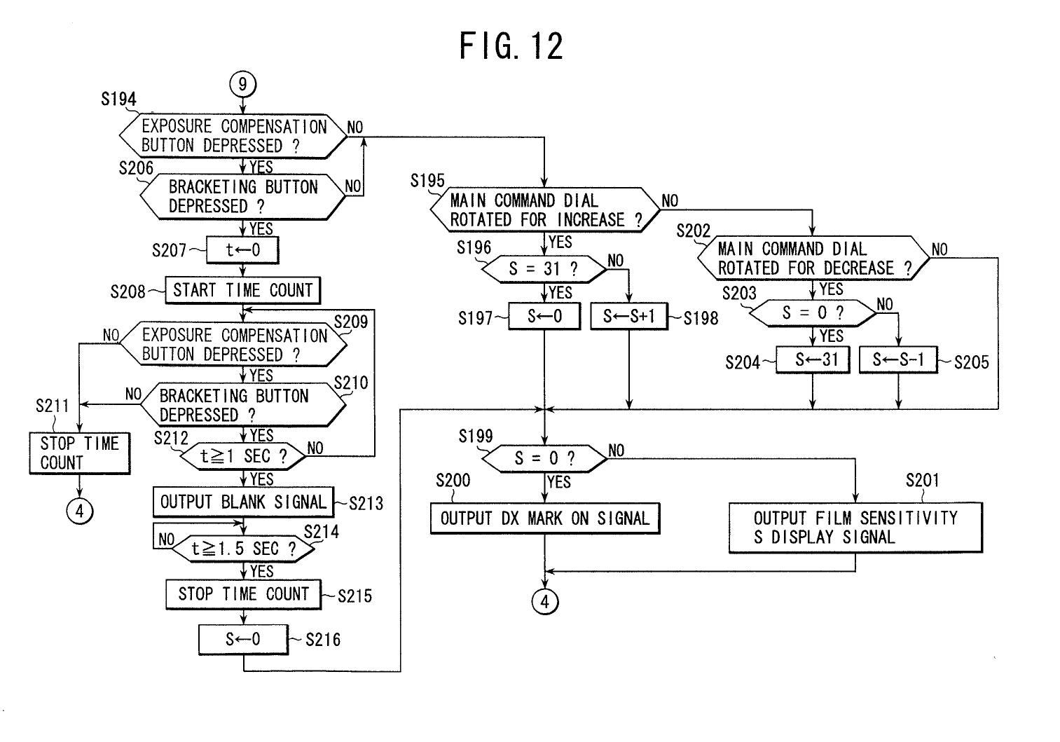

In step S155, a decision is made based upon the states of the switches 401 and 402 as to whether or not the characters “CSM” at the exposure mode dial 400 in FIG. 3 are facing opposite the indicator mark 410. If it is decided that the characters “CSM” are facing opposite the indicator mark 410, the operation proceeds to step S156 to select custom setting. If, on the other hand, it is decided that the characters “CSM” are not facing opposite the indicator mark 410, i.e., if it is decided that the characters “ISO” are facing opposite the indicator mark 410, the operation proceeds to step S194 in FIG. 12 to set the film sensitivity.

In step S156, a decision is made based upon the signal provided from the switch 501 as to whether or not the exposure compensation button 500 in FIG. 3 is depressed. If the exposure compensation button 500 is determined to be depressed, it is judged that a reset operation is in progress and the operation proceeds to step S173, whereas if the exposure compensation button 500 is determined not to be depressed, it is judged that a reset operation is not in progress and the operation proceeds to step S157.

In step S157, a decision is made based upon signals provided from the switches 301 and 302 as to whether or not the main command dial 300 in FIG. 3 has been rotated to increase the setting value (rotated along the counter-clockwise direction in the embodiment). If the main command dial 300 has been rotated along the counter-clockwise direction, the operation proceeds to step S158, but the operation proceeds to step S165 otherwise.

In step S158, a decision is made as to whether or not the value of the parameter I is 4. If the value of the parameter I is 4, the operation proceeds to step S159, whereas if the value is not 4, the operation proceeds to step S160.

In step S159, 1 is set for the parameter I and then the operation proceeds to step S161. In step S160, the value of the parameter I is incremented by 1 and then the operation proceeds to step S161.

Since the value that may be assumed for the parameter I is an integer within the range of 1˜4 in the embodiment as explained earlier, a decision is made as to whether or not the value of the parameter I is the maximum value 4 if an operation to increase the setting value has been performed. If the parameter I is the maximum value 4, the value is reset to 1 so as to change the numerical value cyclically, whereas if the value of the parameter I is not 4, the numerical value is incremented by 1.

In step S161, a custom judging operation identical to the custom judging operation explained earlier is performed. In step S162, a decision is made as to whether or not 1 is set at the custom setting flag C. If the custom setting flag C is determined to be set at 1, it is judged that custom setting is in effect and the operation proceeds to step S163, whereas if 0 is set at the custom setting flag C, it is judged that custom setting is not in effect and the operation proceeds to step S164.

In step S163, a signal for turning on the custom mark 1009, a signal for displaying the custom number at the shutter speed display segment based upon the parameter I and a signal for displaying the value at the flag C(1) (set: 1, not set, i.e., cleared: 0) are output to the drive circuit 103, before the operation returns to step S101 in FIG. 6. At this time, the drive circuit 103 brings up the display based upon the display signals thus output by driving the liquid crystal display unit 102. FIG. 25 shows an example of a display brought up at this point.

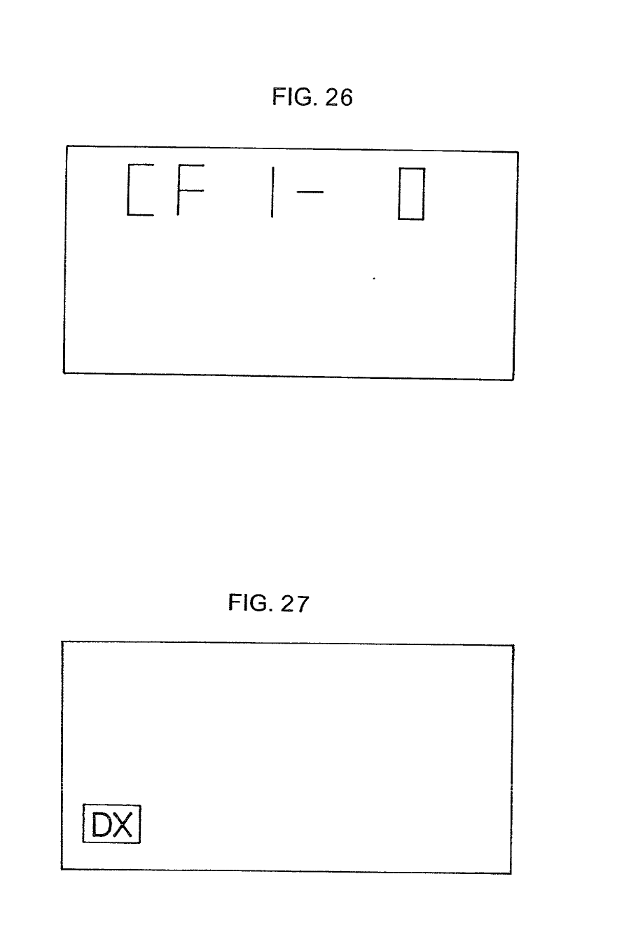

In step S164, a signal for displaying the custom number at the shutter speed display segment based upon the parameter I and a signal for displaying the value at the flag C(1) (set: 1, not set, i.e., cleared: 0) are output to the drive circuit 103, before the operation returns to step S101 in FIG. 6. At this time, the drive circuit 103 brings up the display based upon the display signals thus output by driving the liquid crystal display unit 102. FIG. 26 shows an example of a display brought up at this point.

Since the operation invariably returns to step S101 in FIG. 6 if the characters “CSM” at the exposure mode dial 400 are facing opposite the indicator mark 410 as explained above, the operation does not proceed to step S2 and subsequent steps or step S9 and subsequent steps until the exposure mode dial 400 is set to the “P” position. In other words, a release operation remains prohibited until then.

If it is decided in step S157 that the main command dial 300 has not been rotated in the counter-clockwise direction, the operation proceeds to step S165. In step S165, a decision is made based upon the signals provided from the switches 301 and 302 as to whether or not the main command dial 300 in FIG. 3 has been rotated to decrease the setting value (rotated in the clockwise direction in the embodiment). If the main command dial 300 has been rotated in the clockwise direction, the operation proceeds to step S166, but otherwise it is judged that the main command dial 300 has not been rotated and the operation proceeds to step S169.

In step S166, a decision is made as to whether or not the value of the parameter I is 1. If the value of the parameter I is 1, the operation proceeds to step S167, whereas if the value is not 1, the operation proceeds to step S168.

In step S167, 4 is set for the parameter I and the operation proceeds to step S161 explained earlier. In step S168, the value of the parameter I is incremented by 1 and then the operation proceeds to step S161 explained earlier.

Since the value that may be assumed for the parameter I is an integer within the range of 1˜4 in the embodiment as explained earlier, a decision is made as to whether or not the value of the parameter I is the minimum value 1 if an operation to decrease the setting value has been performed. If the parameter I is the minimum value 1, the value is set to 4 so as to change the numerical value cyclically, whereas if the value of the parameter I is not 4, the numerical value of the parameter I is decremented by 1.

If it is decided in step S165 the main command dial 300 has not been rotated in the clockwise direction, the operation proceeds to step S169. In step S169, a decision is made based upon the signals provided from the switches 201 and 202 as to whether or not the sub-command dial 200 in FIG. 3 has been rotated. If it is decided that the sub-command dial 200 has been rotated, the operation proceeds to step S170, whereas if it is decided that the sub-command dial has not been rotated, the operation proceeds to step S161 explained earlier.

In step S170, a decision is made as to whether or not 1 is set at the flag C(1). If the flag C(1) is determined to be set at 1, the operation proceeds to step S171, whereas if it is decided that 0 is set at the flag C(1), the operation proceeds to step S172.

In step S171, 0 is set at the flag C(1) to clear the custom setting item I through a rotation of the sub-command dial 200, before the operation proceeds to step S161. In step S172, 1 is set at the flag C(1) to set the custom setting item I through a rotation of the sub-command dial 200 before the operation proceeds to step S161.

As described above, if the custom setting item I is currently set, it is cleared but if the custom setting item I is currently cleared, it is set, by rotating the sub-command dial 200.

If it is decided based upon the signal provided from the switch 501 in step S156 that the exposure compensation button 500 in FIG. 3 is depressed, it is judged that a reset operation is in progress and the operation proceeds to step S173.

In step S173, a decision is made based upon the signal provided from the switch 601 as to whether or not the bracketing button 600 in FIG. 3 is depressed. If the bracketing button 600 is determined to be depressed, it is judged that the reset operation is in progress and the operation proceeds to step S174, whereas if the bracketing button 600 is determined not to be depressed, it is judged that the reset operation has been interrupted and the operation proceeds to step S157 explained earlier.

In step S174, the length of time t that has been counted is set to 0 and in step S175, a time count starts.

In step S176, a decision is made based upon the signal provided from the switch 501 as to whether or not the exposure compensation button 500 in FIG. 3 is depressed. If the exposure compensation button 500 is determined to be depressed, it is judged that the reset operation is in progress and the operation proceeds to step S177, whereas if the exposure compensation button 500 is determined not to be depressed, it is judged that the reset operation has been interrupted and the operation proceeds to step S188.

In step S177, a decision is made based upon the signal provided from the switch 601 as to whether or not the bracketing button 600 in FIG. 3 is depressed. If the bracketing button 600 is determined to be depressed, it is judged that the reset operation is in progress and the operation proceeds to step S189, whereas if the bracketing button 600 is determined not to be depressed, it is judged that the reset operation has been interrupted and the operation proceeds to step S188.

In step S188, the time count is stopped and the operation returns to step S101 explained earlier in reference to FIG. 6.

In step S189, a decision is made as to whether or not the length of time t that has been counted is equal to or greater than 1 second. If the time count is 1 second or longer, it is judged that the reset operation has been completed (the exposure compensation button 500 and the bracketing button 600 have been held down at the same time for 1 second or longer) and the operation proceeds to step S190, whereas if the time count is less than 1 second, it is judged that the reset operation has not yet been completed and the operation returns to step S176.

In step S190, a blank signal (a signal for turning off all the segments at the liquid crystal display unit 102) is output to the drive circuit 103. Upon receiving the signal, the liquid crystal display unit 102 becomes completely turned off. FIG. 24 shows the display state at the liquid crystal display unit 102 at this point.

In step S191, a decision is made as to whether or not the length of time t that has been counted is equal to or greater than 1.5 seconds. If the time count is 1.5 seconds or longer, the operation proceeds to step S192, whereas if the time count is less than 1.5 seconds, the operation awaits a time count of 1.5 seconds or longer in step S191. Thus, the liquid crystal display unit 102 sustains the display state shown in FIG. 24 over, at least, 0.5 seconds (500 msec).

After stopping the time count in step S192, the operation proceeds to step S193. In step S193, 0 is set at the flags C(1), C(2), C(3) and C(4) and then the operation proceeds to step S161 explained earlier. As a result, only the function that can be set while the mode dial 400 is set to “CSM” is cleared. Namely, only the function (custom setting function) that can be set if the mode dial 400 is set to the “CSM” position is reset. That a reset has been effected can be easily ascertained since the display at the liquid crystal display unit 102 is turned off (blank display) over, at least, 0.5 seconds (turned off momentarily) in step S190.

If it is decided, based upon the states of the switches 401 and 402 in step S155, that the characters in “CSM” at the exposure mode dial 400 in FIG. 3 are not facing opposite the indicator mark 410, i.e., that the characters “ISO” are facing opposite the indicator mark 410, the operation proceeds to step S194 in FIG. 12.

In step S194, a decision is made based upon the signal provided from the switch 501 as to whether not the exposure compensation button 500 in FIG. 3 is depressed. If the exposure compensation button 500 is determined to be depressed, it is judged that a reset operation is in progress and the operation proceeds to step S206, whereas if the exposure compensation button 500 is determined not to be depressed, it is judged that a reset operation is not in progress and the operation proceeds to step S195.

In step S195, a decision is made based upon the signals provided from the switches 301 and 302 as to whether or not the main command dial 300 in FIG. 3 has been rotated to increase the setting value (rotated along the counter-clockwise direction in the embodiment). If the main command dial 300 has been rotated along the counter-clockwise direction, the operation proceeds to step S196. However, the operation proceeds to step S202 otherwise.

In step S196, a decision is made as to whether or not the value of the parameter S is 31. If the value of the parameter S is 31, the operation proceeds to step S197, whereas if the value is not 31, the operation proceeds to step S198.

In step S197, 0 is set for the parameter S and then the operation proceeds to step S199. In step S198, the value of the parameter S is incremented by 1 and then the operation proceeds to step S199.

Since the value that may be assumed for the parameter S is an integer within the range of 0˜31 in the embodiment as explained earlier, a decision is made as to whether or not the value of the parameter S is the maximum value 31 if an operation to increase the setting value has been performed. If the parameter S is the maximum value 31, the value is reset to 0 so as to change the numerical value cyclically, whereas if the value of the parameter S is not 31, the numerical value is incremented by 1.

In step S199, a decision is made as to whether or not the value of the parameter S is 0. If the value is determined to be 0, the operation proceeds to step S200, whereas if the current value of the parameter S is determined to be a value other than 0, the operation proceeds to step S201.

In step S200, a signal for turning on the DX mark 1006 is output to the drive circuit 103, before the operation returns to step S101 in FIG. 6. At this time response, the drive circuit 103 brings up the display based upon the display signal thus output by driving the liquid crystal display unit 102. FIG. 27 shows an example of a display brought up at this point.

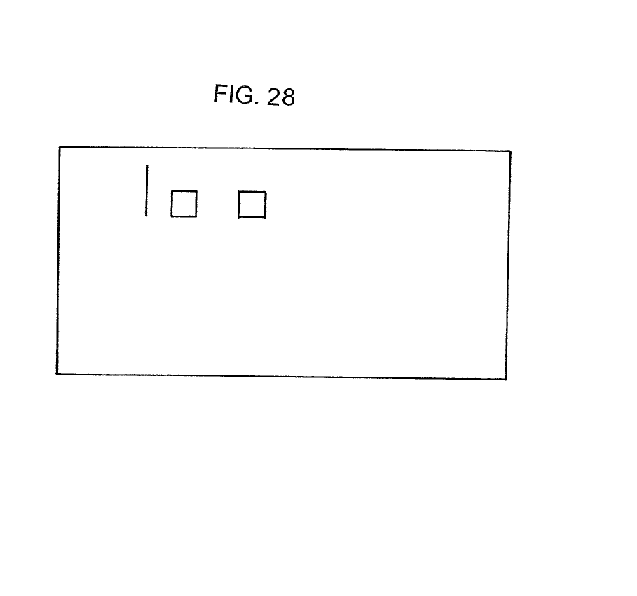

In step S201, a signal for displaying the film sensitivity at the shutter speed display segment based upon the value of the parameter S is output to the drive circuit 103, before the operation returns to step S101 in FIG. 6. At this time, the drive circuit 103 brings up the display based upon the display signal thus output by driving the liquid crystal display unit 102. FIG. 28 shows an example of a display brought up at this point.

If, on the other hand, it is decided in step S195 that the main command dial 300 has not been rotated in the counter-clockwise direction, the operation proceeds to step S202. In step S202, a decision is made based upon the signals provided from the switches 301 and 302 as to whether or not the main command dial 300 in FIG. 3 has been rotated to decrease the setting value (rotated in the clockwise direction in the embodiment). If the main command dial 300 has been rotated in the clockwise direction, the operation proceeds to step S203, but otherwise it is judged that the main command dial 300 has not been rotated and the operation proceeds to step S199.

In step S203, a decision is made as to whether or not the value of the parameter S is 0. If the value of the parameter S is 0, the operation proceeds to step S204, whereas if the value is not 0, the operation proceeds to step S205.

In step S204, 31 is set for the parameter S and the operation proceeds to step S199 explained earlier. In step S205, the value of the parameter S is decremented by 1 and then the operation proceeds to step S199.

Since the value that may be assumed for the parameter S is an integer within the range of 0˜31 in the embodiment as explained earlier, a decision is made as to whether or not the parameter S is the minimum value 0 if an operation to decrease the setting value has been performed. If the parameter S is the minimum value 0, the parameter S is set to 31 so as to change the numerical value cyclically, whereas if the value of the parameter S is not 31, the numerical value of the parameter S is decremented by 1.

If, on the other hand, it is decided in step S194 that the exposure compensation button 500 is depressed, the operation proceeds to step S206. In step S206, a decision is made based upon the signal provided from the switch 601 as to whether or not the bracketing button 600 in FIG. 3 is depressed. If the bracketing button 600 is determined to be depressed, it is judged that the reset operation is in progress and the operation proceeds to step S207, whereas if the bracketing button 600 is determined not to be depressed, it is judged that the reset operation has been interrupted and the operation proceeds to step S195 explained earlier.

In step S207, the length of time t that has been counted is set to 0 and in step S208, a time count starts.

In step S209, a decision is made based upon a signal provided from the switch 501 as to whether or not the exposure compensation button 500 in FIG. 3 is depressed. If the exposure compensation button 500 is determined to be depressed, it is judged that the reset operation is in progress and the operation proceeds to step S210, whereas if the exposure compensation button 500 is determined not to be depressed, it is judged that the reset operation has been interrupted and the operation proceeds to step S211.

In step S210, a decision is made based upon the signal provided from the switch 601 as to whether or not the bracketing button 600 in FIG. 3 is depressed. If the bracketing button 600 is determined to be depressed, it is judged that the reset operation is in progress and the operation proceeds to step S212, whereas if the bracketing button 600 is determined not to be depressed, it is judged that the reset operation has been interrupted and the operation proceeds to step S211.

In step S211, the time count is stopped and the operation returns to step S101 explained earlier in reference to FIG. 6.

In step S212, a decision is made as to whether or not the length of time t that has been counted is equal to or greater than 1 second. If the time count is 1 second or longer, it is judged that the reset operation has been completed (the exposure compensation button 500 and the bracketing button 600 have been held down at the same time for 1 second or longer) and the operation proceeds to step S213, whereas if the time count is less than 1 second, it is judged that the reset operation has not yet been completed and the operation returns to step S209.

In step S213, a blank signal (a signal for turning off all the segments at the liquid crystal display unit 102) is output to the drive circuit 103. In response to this signal, the liquid crystal display unit 102 becomes completely turned off. FIG. 24 shows the display state at the liquid crystal display unit 102 at this time.

In step S214, a decision is made as to whether or not the length of time t that has been counted is equal to or greater than 1.5 seconds. If the time count is 1.5 seconds or longer, the operation proceeds to step S215, whereas if the time count is less than 1.5 seconds, the operation awaits a time count of 1.5 seconds or longer in step S214. Thus, the liquid crystal display unit 102 sustains the display state shown in FIG. 24 over, at least, 0.5 seconds (500 msec).

After stopping the time count in step S215, the operation proceeds to step S216. In step S216, 0 is set for the parameter S and then the operation proceeds to step S199 explained earlier. Thus, the film sensitivity having been set through the film sensitivity setting function that can be set when the characters “ISO” at the mode dial 400 are facing opposite the indicator mark 410 is reset to the film sensitivity automatic setting.

Namely, the film sensitivity that can be set when the mode dial 400 is set to the “ISO” position is reset to the initial state of the film sensitivity automatic setting in step S216. The fact that a reset has been achieved can be easily ascertained since the display at the liquid crystal display unit 102 is turned off (blank display) over, at least, 0.5 seconds (momentarily) in step S213.

As explained above, since the operation invariably returns to step S101 in FIG. 6 if the characters “ISO” at the exposure mode dial 400 are facing opposite the indicator mark 410, the operation does not proceed to step S2 and subsequent steps or step S9 and subsequent steps until the mode dial 400 is set to the “P” position. In other words, a release operation remains prohibited until then.

The setting/display processing is thus completed in step S2.

A further explanation is given by returning to step S3 in FIG. 4. In step S3 in FIG. 4, the back lid detection device 106 detects whether or not the back lid is closed. If is determined to be closed, the operation proceeds to step S4, whereas if it is opened, the operation returns to step S2.

In step S4, the presence/absence of film is detected based upon a signal provided by the film detection device 107. If film has been loaded in the camera, the operation proceeds to step S5, whereas if there is no film in the camera, the operation returns to step S2.

In step S5, a decision is made as to whether or not 0 is set at the flag C(4). A film initial feed is started by closing the back lid when 0 is set at the flag C(4), whereas a film initial feed is started by depressing the shutter release button 900 after closing the back lid when 1 is set at the flag C(4). If it is decided that 0 is set at the flag C(4), the operation proceeds to step S7, whereas if 1 is determined to be set at the flag C(4), the operation proceeds to step S6.

In step S6, a decision is made as to whether or not the shutter release button 900 has been depressed in correspondence to the on/off state of the signal provided from the shutter release switch 901. If it is decided that the shutter release button 900 has been depressed, the operation proceeds to step S7, whereas if it is decided that the shutter release button has not been depressed, the operation remains in step S6 until it is decided that the shutter release button 900 has been depressed.

In step S7, an initial feed is executed to set the first frame of the film in position by winding up the film in response to a signal provided by the film feed device 109. In step S8, the signal indicating the DX code related to the film sensitivity provided at the cartridge is detected and stored in memory. In step S9, the setting/display processing described earlier is implemented.

In step S10, a decision is made based upon the on/off state of the signal from the switch 701 as to whether or not the rewind button 700 has been depressed. If it is decided that the rewind button 700 has been depressed, the operation proceeds to step S31 to be detailed later, whereas if it is decided that the rewind button 700 has not been depressed, the operation proceeds to step S11.

In step S11, a decision is made as to whether not 1 is set at the flag B, i.e., whether or not bracketing is set. If the flag B is determined to be set to 1, the bracketing photographing processing in step S18 and subsequent steps is implemented, whereas if it is determined to be set to 0, the normal photographing processing in step S12 and subsequent steps is implemented.

In step S12, brightness information output by the photometering element 104 is detected.

In step S13, an exposure calculation is performed to calculate the shutter speed and the aperture value. The exposure calculation is performed by using the film sensitivity set in step S2 or step S9 and the brightness information detected in step S12 if the film sensitivity has been manually set. The exposure calculation is performed by using the film sensitivity detected from the cartridge and stored in memory in step S8 and the brightness information detected in step S12 if the film sensitivity automatic setting (DX) is in effect. At this point, an apex operation is performed and the following equation is true with SV representing the film sensitivity, BV representing the subject brightness, TV representing the shutter speed, AV representing the aperture value and EV representing the exposure value.

BV+SV=TV+AV=EV (1)

While the shutter speed TV and the aperture value AV can be calculated once the exposure mode is selected, they may be ascertained in the embodiment through the following formulae, for instance, since the program mode is assumed in the embodiment.

TV=(BV+SV)/2+1=EV/2+1 (2)

AV=(BV+SV)/2−1=EV/2−1 (3)

In step S14, a decision is made based upon the on/off state of the signal provided from the shutter release switch 901 as to whether not the shutter release button 900 has been depressed. If it is decided that the shutter release button has been depressed, the operation proceeds to step S15, whereas if it is decided that the shutter release button has not been depressed, the operation returns to step S9.

In step S15, a photographing operation in which the film is exposed by controlling the exposure control device 105 so as to achieve the shutter speed TV and the aperture value AV having been calculated in step S13, is performed. In step S16, a frame feed is performed by winding up the film by one frame in response to a signal transmitted from the film feed device 109.

In step S17, a decision is made as to whether or not the film has been fed to its rear end based upon an output from the rear end detection device 110. If the film has been fed to the rear end the operation proceeds to step S30 in FIG. 5, whereas if it has not been fed to the rear end, the operation returns to step S9.

If, on the other hand, it is decided in step S11 that 1 is set at the flag B, it is judged that the bracketing has been set and the operation proceeds to step S18. In step S18, brightness information output by the photometering element 104 is detected.

In step S19, the exposure value EV is calculated through formula (4).

EV=BV+SV (4)

Namely, as in step S13 explained earlier the exposure value EV is calculated through formula (4) by using the film sensitivity set in step S2 or step S9 and the brightness information detected in step S18 if the film sensitivity has been set manually, and by using the film sensitivity detected from the cartridge and stored in memory in step S8 and the brightness information detected in step S18 if the film sensitivity automatic setting (DX) is in effect.

In step S20, the bracketing compensation quantity Δ EV is calculated as 2−N. N represents the number of pictures taken through the bracketing photographing operation as explained earlier. It is to be noted that a single compensation step (1EV) is implemented for bracketing in the embodiment.

In step S21, the value obtained by subtracting the bracketing compensation quantity Δ EV calculated in step S20 from the brightness value EV calculated in step S19 is set as the exposure value EV for the bracketing photographing operation.

In step S22, an exposure calculation is performed by calculating the shutter speed and the aperture value through formulae TV=EV/2+1 (2) and AV=EV/2−1 (3) explained earlier.

In step S23, a decision is made based upon the on/off state of the signal provided from the shutter release switch 901 as to whether or not the shutter release button 900 has been depressed. If it is decided that the shutter release button 900 has been depressed, the operation proceeds to step S24, whereas if it is decided that the shutter release button 900 has not been depressed, the operation returns to step S9.

In step S24, a photographing operation in which the film is exposed by controlling the exposure control device 105 so as to achieve the shutter speed TV and the aperture value AV calculated in step S22 is performed.

In step S25, a decision is made as to whether or not 3 is set for the parameter N. Since a bracketing photographing operation is performed over three frames at a time, it is judged that a sequence of auto bracketing photographing operation has been completed if the value of the parameter N is 3 and the operation proceeds to step S26. If, on the other hand, the value of the parameter N is not 3, it is judged that the sequence of the auto bracketing photographing operation is still in progress and the operation proceeds to step S27.

In step S26, the value of the parameter N is set to 1 since the sequence of the auto bracketing photographing operation has been completed. Since the sequence of the auto bracketing photographing operation is still in progress, the value of the parameter N is incremented by one in step S27.

In step S28, a film feed is implemented by winding up the film by one frame in response to a signal transmitted from the film feed device 109. In step S29, a decision is made based upon an output from the rear end detection device 110 as to whether or not the film has been fed to its rear end. If the film is determined to have been fed to its rear end, the operation proceeds to step S30 in FIG. 5, whereas if it has not yet been fed to the rear end, the operation returns to step S9.

If it is decided either in step S17 or step S29 that the film has been fed to its rear end, a film rewind operation is started through the processing in step S30 and subsequent steps in FIG. 5.

In step S30 in FIG. 5, a decision is made as to whether or not 0 is set at the flag C(1). If the flag C(1) is determined to be set to 0, the operation proceeds to step S37 to execute a film rear end auto rewind. If, on the other hand, the flag C(1) is determined not to be set to 0, the operation proceeds to step S31 to start up a film rewind operation even though the film has been fed to its rear end in response to the rewind button 700 being held down over a specific length of time (1 second) or longer.

In step S31, a decision is made based upon the on/off state of the signal provided from the switch 701 as to whether or not the rewind button 700 has been depressed. If it is decided that the rewind button 700 has been depressed, the operation proceeds to step S32, whereas if it is decided that the rewind button 700 has not been depressed, the operation remains in step S31 until the rewind button 700 has been depressed.

In step S32, the length of time t that has been counted is set to 0. In step S33, a time count starts.

In step S34, a decision is made again based upon the on/off state of the signal provided from the switch 701 as to whether or not the rewind button 700 has been depressed. If it is decided that the rewind button 700 has been depressed, the operation proceeds to step S35, whereas if it is decided that the rewind button 700 has not been depressed, the operation returns to step S31.

In step S35, a decision is made as to whether or not the time count t has reached 1 second or higher. If it is decided that the time count has reached 1 second or longer, the operation proceeds to step S36, whereas if it is decided that the time count has not reached 1 second, the operation returns to step S34.

In step S36, the time count is stopped and then, the operation proceeds to step S37. In step S37, a decision is made as to whether or not 0 is set at the flag C(2). If the flag C(2) is determined to be set to 0, it is judged that a fast rewind is to be executed and the operation proceeds to step S38, whereas if the flag C(2) is determined to be set to 1, it is judged that a silent rewind is to be executed and the operation proceeds to step S39.

In step S38, the motor constituting the motive power source for the film feed device 109 is driven at a 100% duty ratio, i.e., driven at full power to execute a fast rewind operation. In step S39, on the other hand, the motor constituting the motive power source of the film feed device 109 is driven at a specific duty ratio (a duty ratio at which approximately 75% of the full power is supplied) to execute a rewind operation by reducing motor noise.

In step S40, a decision is made as to whether or not 0 is set at the flag C(3). If the flag C(3) is determined to be set to 0, the operation proceeds to step S41 to restore the film sensitivity automatic setting (DX) after a film replacement and the subsequent processing is implemented. If, on the other hand, the flag C(3) is determined to be set to a value other than 0, i.e., 1, the operation skips steps S41 and S42 and proceeds to step S43 to sustain the film sensitivity that is currently set.

In step S41, a decision is made as to whether or not a value other than 0 is set for the parameter S. If a value other than 0 is determined to be set for the parameter S, the operation proceeds to step S42 to restore the film sensitivity automatic setting, whereas if 0 is determined to be set for the parameter S, the operation skips step S42 and proceeds to step S43 since the film sensitivity automatic setting is already in effect.

In step S42, 0 is set for the parameter S to restore the film sensitivity of the automatic setting.

In step S43, a detection is performed to determine whether or not the back lid is open based upon a signal provided by the back lid detection device 106. If the back lid is open, the operation proceeds to step S44, whereas if it is closed, the operation remains in step S43 until the back lid is opened.

In step S44, the presence/absence of film is detected based upon the signal provided by the film detection device 107. If no film has been loaded in the camera, the operation proceeds to step S45, whereas if the film is loaded, the operation returns to step S43. In step S45, the value of the parameter F is set to 0 to display “E” at the counter, before the operation returns to step S2.

As explained above in detail, the following numerous advantages are achieved in the embodiment.

(1) Since the display is momentarily turned off by performing a reset operation in the camera reset device in the embodiment, it is easily ascertained that the reset operation is in progress over a specific length of time (the exposure compensation button 500 and the bracketing button 600 have been held down for 1 second or longer in the embodiment).

As a result, even when the user does not hold down the buttons long enough by mistake and, as a result, a reset is not effected, the user can easily ascertain that a reset failure has occurred since the display does not momentarily go off. The camera user is assured that a reset has been effected successfully since the display goes off momentarily when a reset is effected in that case.

(2) Since only the function that can be selected by setting the mode dial to a given position is reset, a camera reset device achieving a high degree of ease of operation, which does not reset functions that the user does not wish to reset and is capable of clearly indicating which function is to be reset is provided.

It is to be noted that while the entire display is momentarily turned off to indicate a reset in the explanation above, the characters RESET may be momentarily displayed or the characters RESET may be lit while the entire display is momentarily turned off, instead.

What is claimed is;

1. A camera comprising;
a display unit that displays a camera setting and/or a control state;
a mode selection unit that selects at least one mode setting position at which a function related to a photographing operation can be selected and set;
a selection/setting operation unit that selects and sets the function;
a reset operation unit that resets the function to a specific initial state; and
a reset control unit that implements reset display on said display unit when said reset operation unit has been operated.

2. A camera according to claim 1, wherein;
a release operation is enabled when said mode selection unit is set in, at least, one first mode setting in which a first function related to a photographing operation can be selected and set and the release operation is prohibited when said mode selection unit is set in, at least, one second mode setting in which a second function other than the first function can be selected and set.

3. A camera according to claim 1, wherein;
said reset control unit indicates a reset by achieving a no-display state over a specific short period of time.

4. A camera according to claim 3, wherein;
said reset control unit indicates a reset by momentarily turning off said display unit.

5. A camera according to claim 1, wherein;
said reset operating unit is provided with two operating members; and
said reset control unit determines that said reset operation unit has been operated when said two operating members have been continuously operated together over a period equal to or greater than a predetermined length of time.

6. A camera reset device comprising;
a mode selection unit that selects, at least, one mode setting state in which a function related to a photographing operation can be selected and set;
a selection/setting operation unit that selects and sets the function;
a reset operation unit that resets the function to a specific initial state; and
a reset control unit that resets only a function which can be selected and set in the mode setting state selected by said mode selection unit when said reset operation unit has been operated.

7. A camera reset device according to claim 6, wherein;
a release operation is enabled when said mode selection unit is set in, at least, one first mode setting in which a first function related to a photographing operation can be selected and set and the release operation is prohibited when said mode selection unit is set in, at least, one second mode setting in which a second function other than the first function can be selected and set.

8. A camera reset device according to claim 7, wherein;
said mode selection unit is capable of selecting, at least, one setting among photographing condition settings in which a photographing condition of a photographing operation started by issuing a photographing start instruction in said camera can be set, a custom setting, in which value settings for a plurality of functions can be set independently of one another and a film sensitivity setting in which the film sensitivity can be set; and
details that can be reset by said reset control unit when said reset operation unit has been operated in a given setting selected by said mode setting unit only include a numerical value or a state that can be set in said setting.
